(19) United States
(12) Patent Application Publication
(10) Pub. No.: US 2024/0408567 A1
(43) Pub. Date: Dec. 12, 2024

(54) Synthesis of porous carbon-based materials from expanded polystyrene

(71) Applicant: Eco Carbon LLC, Bala Cynwyd, PA (US)

(72) Inventors: Dipendu Saha, Claymont, DE (US); Hippolyte A. Grappe, Oak Ridge, TN (US)

(21) Appl. No.: 18/331,974

(22) Filed: Jun. 9, 2023

(51) Int. Cl. B01J 20/20; B01J 20/28; B01J 20/30; C01B 32/318; C01B 32/336; C01B 32/348

(52) U.S. Cl. CPC B01J 20/20; B01J 20/28061; B01J 20/28064; B01J 20/28066; B01J 20/28071; B01J 20/28083; B01J 20/28085; B01J 20/3071; B01J 20/3078; B01J 20/3085; C01B 32/318; C01B 32/336; C01B 32/348; C01P 2002/82; C01P 2002/88; C01P 2002/89; C01P 2004/03; C01P 2006/12; C01P 2006/14; C01P 2006/16

(57) ABSTRACT

A process for synthesizing a carbon molecular sieve and an activated carbon from expanded polystyrene is provided. The process includes sulfonating the expanded polystyrene with sulfuric acid in the presence of a solvent, for example, chloroform, to obtain sulfonated polystyrene; carbonizing the sulfonated polystyrene to obtain a carbon molecular sieve (CMS) with a substantially high degree of porosity; and activating the CMS by adding an activating agent to the CMS to obtain an activated carbon with a substantially high degree of porosity. The activating agent is selected from one or more of steam, potassium hydroxide, carbon dioxide, zinc chloride, phosphoric acid, sodium carbonate, aluminum chloride, magnesium chloride, and sodium hydroxide. A low temperature of, for example, about 50 degrees Celsius, is employed for sulfonating the expanded polystyrene. Heating and cooling operations in the steps of synthesizing and activating the CMS are performed under a nitrogen gas atmosphere.

### BACKGROUND

Expanded polystyrene (EPS), for example, Styrofoam® of DDP Specialty Electronic Materials US, Inc., is widely used in various applications, for example, household and industrial applications such as home and appliance insulation, packaging of materials, manufacture of food containers and insulators, in road bank stabilization systems, etc., worldwide. Expanded polystyrene is one of the single-use plastics with minimum recycling value. Approximately 1% of expanded polystyrene is recycled, while about 99% is disposed as solid waste. Expanded polystyrene-based materials are responsible for about 30% of total landfill waste in the United States of America (USA). In the USA alone, about 1369 tons of expanded polystyrene is accumulated in solid waste every year. Expanded polystyrene is not biodegradable and causes hazardous conditions for both terrestrial and aquatic inhabitants. In the environment, expanded polystyrene may slightly depolymerize to produce traces of styrene, which is a suspected carcinogen. As about 90% of expanded polystyrene is air, expanded polystyrene is substantially light, voluminous, and inexpensive, thereby making conventional recycling of expanded polystyrene unprofitable and not accepted for recycling by most recycling plants. Therefore, upcycling expanded polystyrene-based products into value-added materials may provide a large impetus towards waste minimization and the use of expanded polystyrene. The overall value-added proposition of expanded polystyrene may provide two-fold benefits: (a) removal of non-recyclable expanded polystyrene waste that is a pollutant; and (b) utilization of the same pollutant for the abatement of other pollutants.

While some efforts have been made in utilizing waste expanded polystyrene, for example, in liquefaction of expanded polystyrene by pyrolysis, limited or no efforts have been made in synthesis of carbon-based materials from expanded polystyrene. Moreover, pristine expanded polystyrene has no char or carbon yield upon carbonization. Pristine expanded polystyrene refers to expanded polystyrene in its original, pure, unmodified, and clean form. Carbonization is a process of heating a carbonaceous material, for example, at about 800 degrees Celsius (C) at a ramp rate of, for example, about 10° C. per minute, in the absence of air and under a flow of nitrogen gas (N₂). Char is the solid, residual carbon material that remains after light gases, for example, hydrocarbon gases and tar, have been driven out or released from combustion of the carbonaceous material. Some efforts have demonstrated the conversion of expanded polystyrene into other products with possible high value, while others have demonstrated the liquefaction of expanded polystyrene by pyrolysis in moderate to high temperatures that mostly produces about 94% to about 96% of liquid products comprising a styrene monomer along with a small amount of benzene, toluene, xylene, ethylbenzenes, and other organic products. Reactors and catalysts of various types have been employed to facilitate the liquefaction. Different approaches that have been adopted for liquefaction of expanded polystyrene comprise, for example, classical heating in reactors of different types, in a microwave-based system, in solvent-assisted processes, in catalytic pyrolysis, and in co-pyrolysis with other materials. Each process has its own set of advantages and disadvantages. In a different approach, nitrated and sulfonated polystyrene was employed as an ion-exchange agent for the removal of heavy-metals from water. Other efforts in the utilization of expanded polystyrene comprise, for example, recovery of styrene from used polystyrene, developing a method and a system for recovering styrene containing liquid, catalytic cracking of polystyrene by Zeolite Socony Mobil-5 (ZSM-5), pyrolysis of polystyrene in an oxygen-free environment to produce gaseous products, and developing a generalized design of reactor systems for pyrolysis of polystyrene.

The science and technology of creating porous carbon-based materials from expanded polystyrene are significant. Some efforts demonstrated that expanded polystyrene can be converted into carbon directly without a precursor modification. Such a demonstration contradicts observations that pristine expanded polystyrene does not yield any carbon residue. There are limited or no protocols of synthesis and data about producing activated carbon from expanded polystyrene upon modification. Other efforts demonstrated the production of activated carbon from a mixture of used polyethylene terephthalate (PET) and expanded polystyrene. In this method, the generated carbon most likely originated from the polyethylene terephthalate and food waste associated with the expanded polystyrene only; that is, the expanded polystyrene itself did not contribute to a carbon yield.

A carbon molecular sieve (CMS) is a type of nanoporous carbon that contains substantially narrow and specific pores within its metrics. Conventionally, and in most cases, the carbon molecular sieve contains two types of interconnected pores. The first type of pores are ultramicropores with a pore width of, for example, less than about 7 angstroms, and the second type of pores are pores with larger micropores with a pore width of, for example, less than about 20 angstroms. While some carbons with mesoporosity, for example, with a pore width of greater than about 20 angstroms, have also been claimed as a carbon molecular sieve, in most cases, the carbon molecular sieve referred to herein is carbon with two types of micropores only, namely, carbon with a pore width of less than about 7 angstroms, and carbon with a pore width of less than about 20 angstroms. A carbon molecular sieve is conventionally produced by carbonizing different types of organic polymers, mostly of a polyimide type. The carbon molecular sieve is typically produced from a commercially available polyimide, for example, Matrimid® of Hunstman Advanced Materials Americas LLC, by carbonizing the polyimide, for example, at about 550° C. to about 800° C. Fluorinated dianhydride, 4,4′-(hexafluoroisopropylidene)diphthalic anhydride, abbreviated as 6-FDA, and its associated copolymers have also been used to synthesize carbon molecular sieves by carbonizing 6-FDA and its associated copolymers, for example, at about 550° C. to about 750° C.

Different types of copolymers of FDA that have been used to synthesize the carbon molecular sieve are, for example, 6-FDA-BPDA-DAM, 6-FDA-DABA, 6-FDA-DETDA-DABA, 6-FDA-DAM, 6-FDA-DAM-DABA, and other 6-FDA-based polyimides, where 6-FDA refers to 4,4′-(hexafluoroisopropylidene)diphthalic anhydride; BPDA refers to 3,3′-4,4′-biphenyl tetracarboxylic dianhydride; DAM refers to 2,4,6 trimethyl-3,3-phenylenediamine; DABA refers to 3,5-diaminobenzoic acid; and DETDA refers to 2,5-diethyl-6-methyl-1,3-diaminobenzene. Furthermore, other types of polymers, for example, BPDA-based polymers, PMDA-pDA, NTDA-BDSA-BAPF, PIM, and phenolic resins, have also been used to synthesize the carbon molecular sieve, where PMDA refers to pyromellitic dianhydride; NTDA refers to 1,4,5,8-naphthalene tetracarboxylic dianhydride; BDSA refers to benzidine-2,2′-disulfonic acid; BAPF refers to 9,9′-bis(4-aminophenyl) fluorene; and PIM refers to polymer of intrinsic microporosity. Typically, in the course of carbonization, the polymer is first converted into aromatic strands which are then organized to form plates. The neighboring plates may assemble to form irregular cellular structures. The ultramicropores are typically formed in between strands and plates, whereas the larger micropores are formed within the cellular structures.

Activated carbon is a more general term for porous carbon. Activated carbon finds widespread applications in numerous fields comprising, for example, water purification, air purification, supercapacitors, catalyst supports, medical fields, etc. In terms of its size, activated carbon is typically classified in the following two categories: powdered activated carbon (PAC) and granular activated carbon (GAC). Activated carbon can be produced from a broad class of natural and synthetic carbonaceous precursors. Two common types of precursors that have been employed for the commercial production of activated carbons are coconut shells and coal particles. Several types of bio-based waste materials have also been employed for synthesis of activated carbon. These precursors comprise, for example, seeds, shells or peels of different types of fruits, bagasse, straw, rice husk, corn cob, coffee residue, lignin, biochar, etc. The porosity of the activated carbon is increased by activation. Activation is a process of treating carbon with an activating agent. Three common types of activating agents are carbon dioxide (CO₂), steam, and potassium hydroxide (KOH).

Production of activated carbon from plastic-based materials is rare compared to the production of activated carbons from the conventional precursors recited above. Different types of plastic-based materials that have been employed are, for example, polyethylene terephthalate (PET), miscellaneous “dirty” plastic mixtures from agricultural and urban plastic residue comprising, for example, milk bottle caps, straws used in juice packets, milk package tips, cotton swabs, cigarette filters, clothing fibers, etc., electron waste plastics, mostly containing styrene acrylonitrile (SAN), waste tires, polyacrylonitrile (PAN), and polyvinyl chloride (PVC). Among the limited number of plastic-based materials, pristine and mixtures, polyethylene terephthalate has been most widely applied for the synthesis of activated carbons.

While value-added utilization of expanded polystyrene mostly dealt with the catalytic and non-catalytic liquefaction of expanded polystyrene generating liquid styrene, there is a need for converting expanded polystyrene into activated carbon or any carbon, in general. A problem associated with the conversion of expanded polystyrene into carbonaceous materials is that expanded polystyrene does not yield a char value, thereby suggesting that the expanded polystyrene does not produce carbon under carbonization, under an inert atmosphere. As used herein, “char value” refers to an amount of “char”, that is, carbon, obtained upon carbonization. The unit of char value is weight percent (weight %).

Hence, there is a long-felt need for a process for synthesizing porous carbon-based materials, such as a carbon molecular sieve and an activated carbon, from expanded polystyrene. Furthermore, there is a need for changing the char yielding behavior of expanded polystyrene by chemically modifying the expanded polystyrene and thereafter synthesizing a carbon molecular sieve and an activated carbon from the chemically modified expanded polystyrene.

### SUMMARY OF THE INVENTION

This summary is provided to introduce a selection of concepts in a simplified form that are further disclosed in the detailed description of the invention. This summary is not intended to determine the scope of the claimed subject matter.

The process disclosed herein addresses the above-recited need for synthesizing porous carbon-based materials, such as a carbon molecular sieve and an activated carbon, from expanded polystyrene (EPS), by first synthesizing the carbon molecular sieve, and thereafter, activating the carbon molecular sieve to obtain an activated carbon. Activated carbon is the second product that is obtained from the first product, namely, the carbon molecular sieve. Furthermore, the process disclosed herein addresses the above-recited need for changing the char yielding behavior of expanded polystyrene by chemically modifying the expanded polystyrene, for example, by sulfonation, and thereafter synthesizing a carbon molecular sieve and an activated carbon from the sulfonated polystyrene. To alter the char yielding characteristic of expanded polystyrene, in an embodiment, the process disclosed herein comprises chemically modifying the expanded polystyrene followed by carbonization to obtain a carbon molecular sieve, and thereafter activating the carbon molecular sieve with conventional techniques to increase the porosity of the carbon in the carbon molecular sieve.

The process for synthesizing a carbon molecular sieve and an activated carbon from expanded polystyrene comprises: (a) sulfonating the expanded polystyrene with sulfuric acid in the presence of a solvent to obtain sulfonated polystyrene; (b) carbonizing the sulfonated polystyrene to obtain a carbon molecular sieve; and (c) activating the carbon molecular sieve by adding an activating agent to the carbon molecular sieve to obtain an activated carbon. The activating agent is selected, for example, from one or more of steam, potassium hydroxide, carbon dioxide, zinc chloride, phosphoric acid, sodium carbonate, aluminum chloride, magnesium chloride, and sodium hydroxide.

In an embodiment, the process for sulfonating the expanded polystyrene comprises the following steps:
(i) Dissolving about 1% to about 30% by weight per volume (w/v) of expanded polystyrene in about 80% to about 99% by volume of a solvent, for example, an organic solvent such as chloroform, dichloromethane, acetone, N,N-dimethyl formamide (DMF), dimethyl sulfoxide (DMSO), tetrahydrofuran (THF), toluene, or benzene, to obtain a solution;
(ii) Adding about 95% to about 98% by weight of concentrated sulfuric acid to the solution to obtain a mixture;
(iii) Heating the mixture to a predetermined temperature of, for example, about 50 degrees Celsius (° C.), in a heating bath, for example, a silicone oil bath, under constant stirring for a predetermined time period of, for example, about 5 hours;
(iv) Quenching the heated mixture in deionized water, or in an embodiment, in water;
(v) Stirring the quenched mixture for a predetermined time period of, for example, about 8 hours or overnight, to obtain sulfonated polystyrene;
(vi) Washing the sulfonated polystyrene multiple times, for example, about five times, with deionized water, or in an embodiment, with water;
(vii) Separating the washed sulfonated polystyrene; and
(viii) Drying the separated sulfonated polystyrene in a muffle furnace at a predetermined temperature of, for example, about 100° C., for a predetermined time period of, for example, about 8 hours or overnight, to obtain a solid mass of sulfonated polystyrene flakes.

In an embodiment, the process for synthesizing the carbon molecular sieve (CMS) comprises carbonizing the solid mass of sulfonated polystyrene flakes in a tube furnace at a predetermined elevated temperature of, for example, about 800° C., at a predetermined ramp rate of, for example, about 10° C./min, and cooling the carbonized mass to room temperature. After the carbon molecular sieve is synthesized, the carbon molecular sieve is activated. In an embodiment, heating and cooling operations in the process are performed under a nitrogen gas (N₂) flow. In an embodiment, the carbon molecular sieve is activated by potassium hydroxide to obtain an activated carbon. In another embodiment, the carbon molecular sieve is activated by steam to obtain an activated carbon. In another embodiment, the carbon molecular sieve is activated by any one or more of carbon dioxide, zinc chloride, phosphoric acid, sodium carbonate, aluminum chloride, magnesium chloride, and sodium hydroxide. In an embodiment, in step (ii) of the process disclosed above, the concentrated sulfuric acid in the mixture is adjusted to maintain an expanded polystyrene-to-acid ratio of, for example, about 0.11 to about 3.61. In an embodiment, about 95% to about 98% by weight of the concentrated sulfuric acid is added to about 1% to about 30% by weight per volume of the expanded polystyrene directly without dissolution of the expanded polystyrene in the solvent for sulfonation of the expanded polystyrene.

In the process disclosed herein, the carbon molecular sieve and the activated carbon are produced with a substantially high degree of porosity. The surface area of the carbon molecular sieve ranges, for example, from about 360 square meters per gram (m²/g) to about 489 m²/g, and the pore volume of the carbon molecular sieve ranges, for example, from about 0.19 m²/g to about 0.24 m²/g, with key or prominent pore widths, for example, around 3.5 angstroms (Å) to about 8.5 Å. The surface area of the activated carbon ranges, for example, from about 994 m²/g to about 3039 m²/g, and the pore width of the activated carbon ranges, for example, from about 0.45 cubic centimeters per gram (cm³/g) to about 1.38 cm³/g.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific processes and structures disclosed herein. The description of a process step or a structure referenced by a numeral in a drawing is applicable to the description of that process step or structure shown by that same numeral in any subsequent drawing herein.

FIG. 1A illustrates a flowchart of a process for synthesizing a carbon molecular sieve and an activated carbon from expanded polystyrene.

FIG. 1B illustrates a flowchart of an embodiment of the process for synthesizing a carbon molecular sieve and an activated carbon from expanded polystyrene.

FIG. 2A illustrates an experimental setup for synthesizing a carbon molecular sieve from expanded polystyrene.

FIG. 2B illustrates an experimental setup for an embodiment of a process for synthesizing an activated carbon from the carbon molecular sieve.

FIG. 2C illustrates an experimental setup for another embodiment of a process for synthesizing an activated carbon from the carbon molecular sieve.

FIG. 3A illustrates a schematic of the synthesis of a carbon molecular sieve from expanded polystyrene.

FIG. 3B illustrates a schematic of the synthesis of an activated carbon from the carbon molecular sieve.

FIG. 4A illustrates a graphical representation showing a thermogravimetric analysis of modified expanded polystyrene.

FIG. 4B illustrates a graphical representation showing a derivative of the thermogravimetric analysis plot shown in FIG. 4A, where an inset plot shows pristine expanded polystyrene.

FIG. 4C illustrates a graphical representation showing a percent of carbon yield as a function of an acid-to-expanded polystyrene ratio.

FIG. 5 illustrates a graphical representation showing Fourier transform infrared (FTIR) data of pristine expanded polystyrene, sulfonated polystyrene with an acid/expanded polystyrene (A/E) ratio of 1.75 milliliters per gram (mL/g), and partially sulfonated and partially pyrolyzed polystyrene at 300° C.

FIG. 6A illustrates a graphical representation showing transformation of carbon, oxygen, and sulfur from sulfonated polystyrene to a carbon molecular sieve.

FIG. 6B illustrates a graphical representation showing C-1s peak spectra in the sulfonated polystyrene, partially pyrolyzed expanded polystyrene, and the carbon molecular sieve.

FIG. 6C illustrates a graphical representation showing O-1s peak spectra in the sulfonated polystyrene, the partially pyrolyzed expanded polystyrene, and the carbon molecular sieve.

FIG. 6D illustrates a graphical representation showing S-2p peak spectra in the sulfonated polystyrene, the partially pyrolyzed expanded polystyrene, and the carbon molecular sieve.

FIG. 7A illustrates a total ion chromatogram (TIC) of pristine expanded polystyrene.

FIG. 7B illustrates a mass spectrum for evolved gas analysis of the pristine expanded polystyrene at 21.95 minutes.

FIG. 7C illustrates a graphical representation showing evolved gas intensity for an acid/expanded polystyrene (A/E) ratio of 1.75 and A/E=3.61.

FIG. 7D illustrates a total ion chromatogram (TIC) of an acid/expanded polystyrene (A/E) ratio of 1.75.

FIGS. 7E-7G illustrate mass spectra of the acid/expanded polystyrene (A/E) ratio of 1.75 at 19.13 minutes, 41.31 minutes, and 65.09 minutes, respectively.

FIG. 7H illustrates a total ion chromatogram (TIC) of an acid/expanded polystyrene (A/E) ratio of 3.61.

FIGS. 7I-7L illustrate mass spectra of the acid/expanded polystyrene (A/E) ratio of 3.61 at 5.63 minutes, 22.08 minutes, 62.53 minutes, and 66.81 minutes, respectively.

FIGS. 8A-8H illustrate representative scanning electron microscopy images of sulfonated polystyrene with an acid/expanded polystyrene (A/E) ratio of 1.75 mL/g.

FIG. 9 illustrates a graphical representation showing a correlation of a Brunauer-Emmett-Teller (BET) surface area and micropore volume with the acid/expanded polystyrene ratio.

FIG. 10 illustrates nitrogen gas (N₂) adsorption-desorption plots at 77 Kelvin (K) for carbon molecular sieves produced from sulfonated polystyrene.

FIG. 11 illustrates a graphical representation showing pore size distribution obtained by a non-local density functional theory (NLDFT) analysis.

FIG. 12 illustrates nitrogen gas (N₂) adsorption-desorption plots at 77 Kelvin (K) for activated carbons produced by potassium hydroxide activation and steam activation.

FIG. 13 illustrates a graphical representation showing pore size distribution of potassium hydroxide-activated carbons and steam-activated carbons.

FIG. 14 illustrates a graphical representation showing adsorption isotherms of small-molecule gases on an acid/expanded polystyrene (A/E) ratio of 1.75 mL/g at 298 Kelvin (K).

FIG. 15 illustrates a graphical representation showing adsorption isotherms of carbon dioxide (CO₂), methane (CH₄), and nitrogen gas (N₂) on expanded polystyrene-potassium hydroxide-3 and expanded polystyrene-steam-3 at 298 K.

FIG. 16 illustrates a graphical representation showing low-pressure adsorption kinetics of gases on an acid/expanded polystyrene (A/E) ratio of 1.75 mL/g at 298 K, where an inset plot shows a correlation of diffusive time constants with a kinetic diameter.

FIG. 17 illustrates a graphical representation showing an ideal adsorbed solution theory (IAST)-selectivity of gas pairs on an acid/expanded polystyrene (A/E) ratio of 1.75 mL/g at 298 K.

FIGS. 18A-18C illustrate graphical representations showing an ideal adsorbed solution theory (IAST)-selectivity of gas pairs on potassium hydroxide-activated carbons and steam-activated carbons at 298 K.

FIG. 19 illustrates a graphical representation showing water purification characteristics of potassium hydroxide-activated carbons and steam-activated carbons at 298 K.

### DETAILED DESCRIPTION OF THE INVENTION

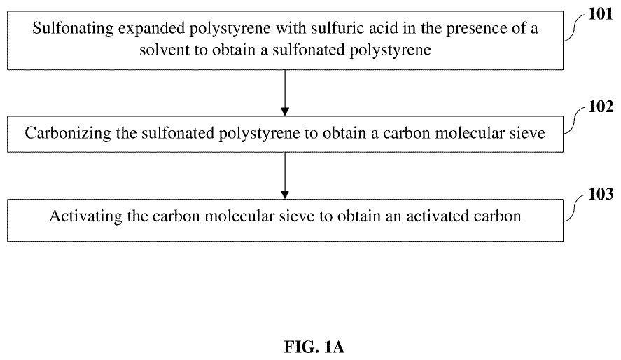

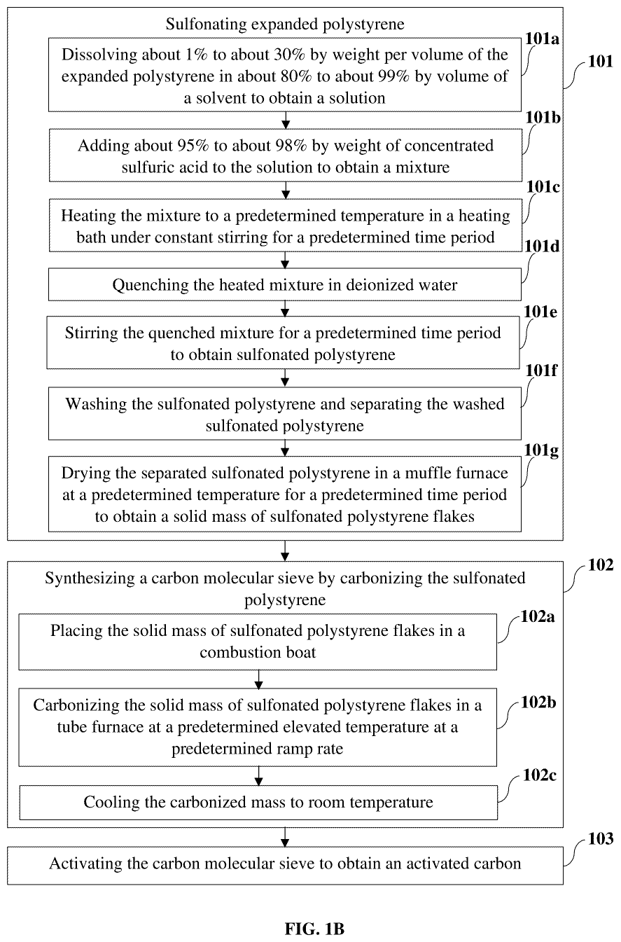

FIG. 1A illustrates a flowchart of a process for synthesizing a carbon molecular sieve and an activated carbon from expanded polystyrene (EPS). The process for synthesizing a carbon molecular sieve and an activated carbon from expanded polystyrene comprises: (a) sulfonating 101 the expanded polystyrene with sulfuric acid in the presence of a solvent to obtain sulfonated polystyrene; (b) carbonizing 102 the sulfonated polystyrene to obtain a carbon molecular sieve; and (c) activating 103 the carbon molecular sieve by adding an activating agent to the carbon molecular sieve to obtain an activated carbon. The solvent is selected, for example, from one or more of chloroform, dichloromethane, acetone, N,N-dimethyl formamide, dimethyl sulfoxide, tetrahydrofuran, toluene, and benzene. The activating agent is selected, for example, from one or more of steam, potassium hydroxide, carbon dioxide, zinc chloride, phosphoric acid, sodium carbonate, aluminum chloride, magnesium chloride, and sodium hydroxide. In the process disclosed herein, the carbon molecular sieve and the activated carbon, when synthesized, are produced with a substantially high degree of porosity, with the surface area of the carbon molecular sieve ranging, for example, from about 360 square meters per gram (m²/g) to about 489 m²/g, and the pore volume of the carbon molecular sieve ranging, for example, from about 0.19 m²/g to about 0.24 m²/g, with key or prominent pore widths, for example, around 3.5 angstroms (Å) to about 8.5 Å, and with the surface area of the activated carbon ranging, for example, from about 994 m²/g to about 3039 m²/g, and the pore width of the activated carbon ranging, for example, from about 0.45 cubic centimeters per gram (cm³/g) to about 1.38 cm³/g.

FIG. 1B illustrates a flowchart of an embodiment of the process for synthesizing a carbon molecular sieve and an activated carbon from expanded polystyrene. As disclosed in the description of FIG. 1A, the first step of the process comprises sulfonating 101 the expanded polystyrene with sulfuric acid in the presence of a solvent to obtain sulfonated polystyrene. In an embodiment of the process for sulfonating 101 the expanded polystyrene, about 1% to about 30% by weight per volume (w/v) of expanded polystyrene is dissolved 101a in about 80% to about 99% by volume of an organic solvent, for example, chloroform, in a first container, for example, a 200-milliliter (mL) round bottom flask to obtain a solution. About 95% to about 98% by weight of concentrated sulfuric acid is added 101b to the solution in the first container to obtain a mixture. In an embodiment, the concentrated sulfuric acid in the mixture is adjusted to maintain an expanded polystyrene-to-acid ratio of, for example, about 0.11 to about 3.61. In an embodiment, about 95% to about 98% by weight of the concentrated sulfuric acid is added to about 1% to about 30% by weight per volume of the expanded polystyrene directly without dissolution of the expanded polystyrene in the organic solvent within the first container for sulfonation of the expanded polystyrene. The first container and the mixture contents therein are heated in a heating bath, for example, a silicone oil bath, under constant stirring with the heating bath fitted with a reflux system on top of the first container. The mixture with the added concentrated sulfuric acid is heated 101c to a predetermined temperature of, for example, about 50 degrees Celsius (° C.), in the heating bath under constant stirring for a predetermined time period of, for example, about 5 hours. The heated mixture is quenched 101d in deionized water in a second container. In an embodiment, the heated mixture is quenched in water. The quenched mixture is stirred 101e for a predetermined time period of, for example, about 8 hours or overnight, to obtain sulfonated polystyrene. The sulfonated polystyrene is washed 101f multiple times, for example, about five times, with deionized water, or in an embodiment with water, and the washed sulfonated polystyrene is separated therefrom. The separated sulfonated polystyrene is dried 101g in a muffle furnace at a predetermined temperature of, for example, about 100° C., for a predetermined time period of, for example, about 8 hours or overnight, to obtain a solid mass of sulfonated polystyrene flakes.

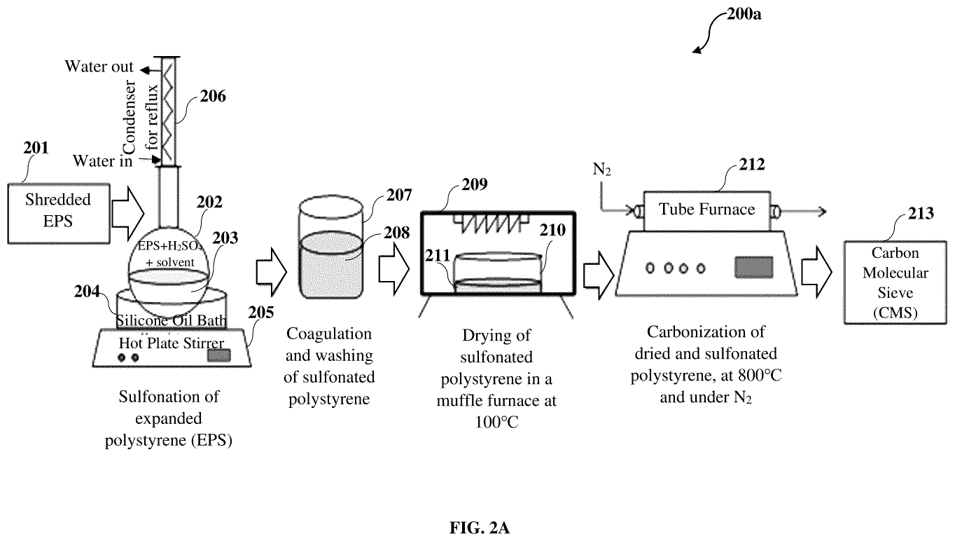

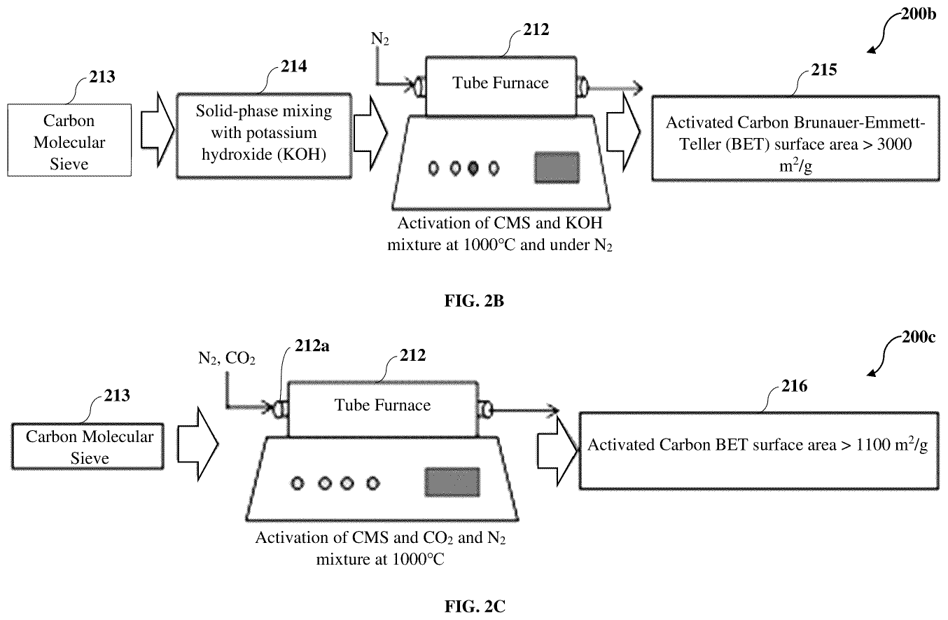

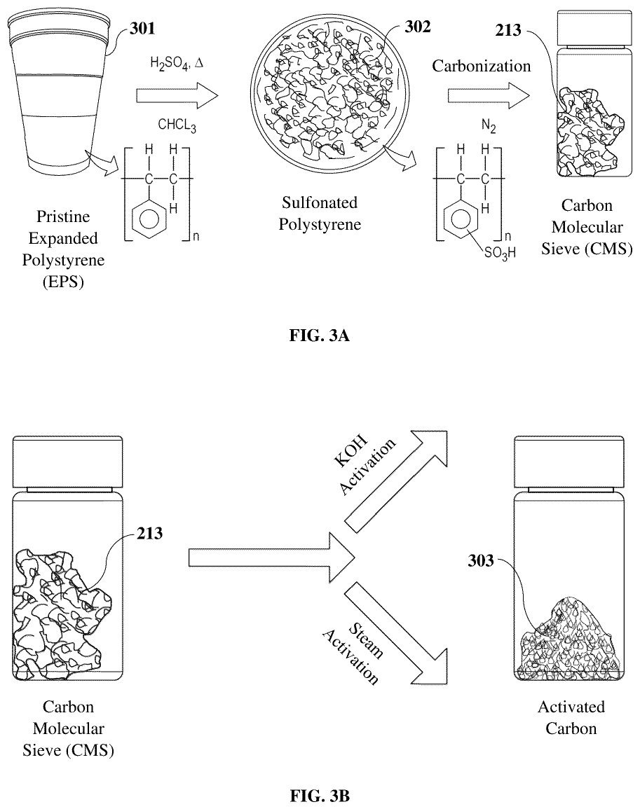

As disclosed in the description of FIG. 1A, the second step of the process comprises synthesizing a carbon molecular sieve (CMS) by carbonizing 102 the sulfonated polystyrene. As illustrated in FIG. 1B, the carbon molecular sieve is synthesized 102 by placing 102a the solid mass of sulfonated polystyrene flakes in a combustion boat, for example, a porcelain boat; carbonizing 102b the solid mass of sulfonated polystyrene flakes in a tube furnace, for example, a Lindberg/Blue M™ tube furnace, at a predetermined elevated temperature of, for example, about 800° C., at a predetermined ramp rate of, for example, about 10° C./min; and cooling 102c the carbonized mass to room temperature. The heating time in the Lindberg/Blue M™ tube furnace is, for example, about 80 minutes, and the cooling time is, for example, about 90 minutes to about 100 minutes, resulting in a total carbonization time of about 3 hours. In an embodiment, the heating and cooling operations in the process disclosed above are performed under a nitrogen gas (N₂) atmosphere. As disclosed in the description of FIG. 1A, the third step of the process comprises activating 103 the carbon molecular sieve by adding one or more activating agents to the carbon molecular sieve to obtain an activated carbon. In an embodiment, the carbon molecular sieve is activated by potassium hydroxide. In another embodiment, the carbon molecular sieve is activated by water or steam. Activation of the carbon molecular sieve by potassium hydroxide and by steam are disclosed in the description of FIGS. 2B-2C and FIG. 3B. In another embodiment, the carbon molecular sieve is activated by any one or more of carbon dioxide (CO₂), zinc chloride (ZnCl₂), phosphoric acid (H₃PO₄), sodium carbonate (Na₂CO₃), aluminum chloride (AlCl₃), magnesium chloride (MgCl₂), and sodium hydroxide (NaOH).

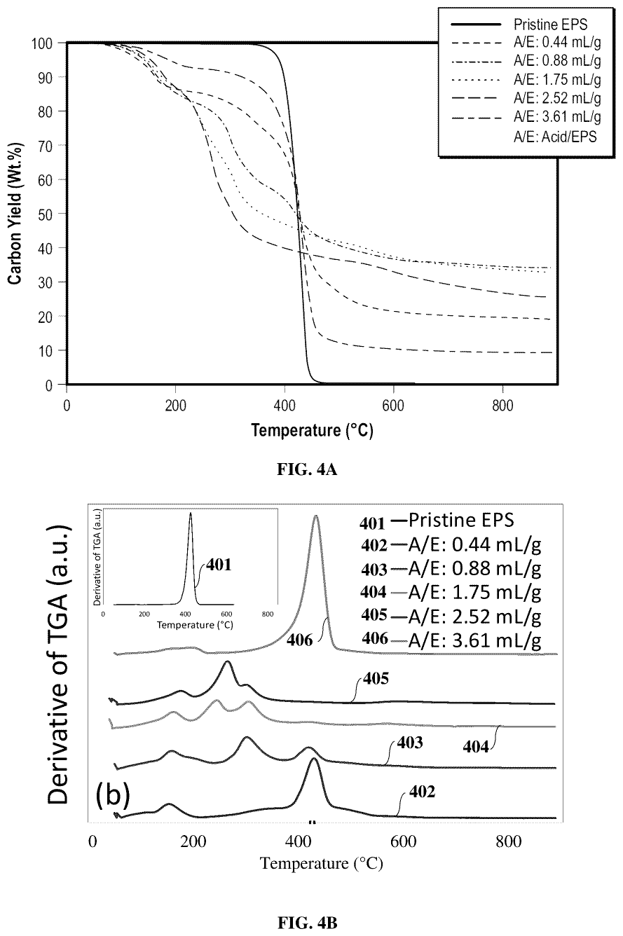

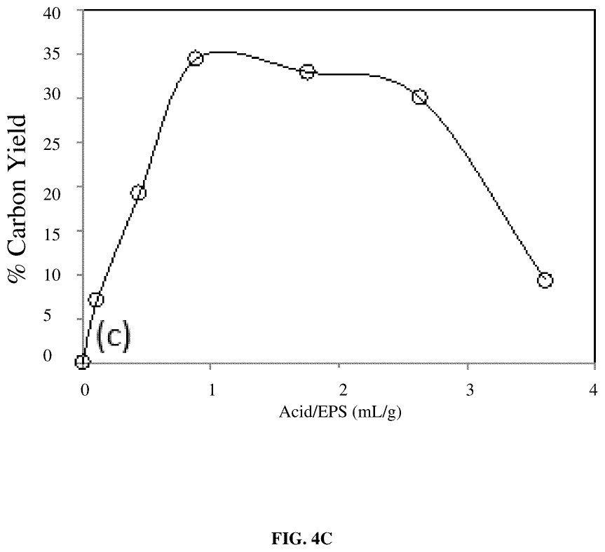

FIG. 2A illustrates an experimental setup 200a for synthesizing a carbon molecular sieve 213 from expanded polystyrene 201. The experimental setup 200a comprises, for example, a 200 mL round bottom flask 202 used as a first container, a reflux system 206 implemented as a condenser, a heating bath 204, for example, a silicone heating bath, a hot plate stirrer 205, a muffle furnace 209, and a tube furnace 212. In an embodiment, the carbon molecular sieve 213 is synthesized by a two-step process from expanded polystyrene 201. In the first step, expanded polystyrene 201 is sulfonated. To sulfonate expanded polystyrene 201, in an example, about 4.5 grams (g) of shredded, expanded polystyrene 201 from various sources, for example, clean packaging, clean food containers, etc., is dissolved in about 38 mL of an organic solvent, for example, chloroform (CHCl₃), in the round bottom flask 202. In an embodiment, the expanded polystyrene is pristine expanded polystyrene. In an embodiment, organic solvents other than chloroform are employed for sulfonation of expanded polystyrene. In another embodiment, sulfonation is carried out without a solvent. A predetermined amount ranging, for example, from about 95% to about 98% by weight of concentrated sulfuric acid (H₂SO₄) is added to the expanded polystyrene and the organic solvent in the round bottom flask 202 to obtain a mixture 203. For example, about 96% by weight of concentrated sulfuric acid is added to the expanded polystyrene and the organic solvent in the round bottom flask 202. In an embodiment, the volume of sulfuric acid varies, for example, from about 4 mL to about 16 mL, to create different degrees of sulfonation of the expanded polystyrene as illustrated in FIGS. 4A-4C. The round bottom flask 202 with the expanded polystyrene, the organic solvent, and the concentrated sulfuric acid is then heated in the heating bath 204, for example, a silicone oil bath, under constant stirring by the hot plate stirrer 205. The reflux system 206 is fitted on top of the round bottom flask 202. In an embodiment, reflux is performed with cold tap water. The mixture 203 in the round bottom flask 202 is heated, for example, to about 50° C. for about 5 hours. After sulfonation is complete, the round bottom flask 202 contains sulfonated polystyrene, unreacted sulfuric acid, and the organic solvent.

At the end of the sulfonation reaction, the sulfonated polystyrene, the unreacted sulfuric acid, and the organic solvent mixture 203 in the round bottom flask 202 is quenched, for example, in about 1 liter (L) of deionized (DI) water, in another container 207 and stirred continuously, overnight. A white to light pink colored, fluffy sulfonated polystyrene mass forms in the deionized water by coagulation. In the process of coagulation, when the mixture contents are poured into the deionized water, the sulfonated polystyrene, which is insoluble in water, forms a precipitate. The coagulated mass 208 formed in the container 207 is washed several times, for example, about five times, with deionized water for about 8 hours and then separated from the deionized water. In an embodiment, the coagulated mass 208 is filtered and hand-pressed with a mesh to remove majority of the deionized water from the coagulated mass 208. The separated, sulfonated polystyrene 211 is placed in another container 210 and introduced into the muffle furnace 209. The sulfonated polystyrene 211 is dried in the muffle furnace 209, for example, at about 100° C. for about 8 hours to overnight to obtain a solid mass of sulfonated polystyrene flakes. In the course of sulfonation, the concentrated sulfuric acid is adjusted to maintain the expanded polystyrene/acid ratio, for example, to about 0.11 to about 3.61. The moisture content of the sulfonated polystyrene after the drying process in the muffle furnace 209 is, for example, about 10% to about 30% by weight of the sulfonated polystyrene as determined by thermogravimetric analysis (TGA). In an example, 4.5 grams of the expanded polystyrene yields about 16.6 grams of sulfonated polystyrene. The sulfonated polystyrene has a volatile moisture content of, for example, about 10% to about 30% as determined by thermogravimetric analysis.

In the second step of the process, the carbon molecular sieve 213 is synthesized by placing the sulfonated polystyrene in a porcelain boat and heating the sulfonated polystyrene and the porcelain boat in the tube furnace 212, for example, a Lingberg/Blue M™ Mini-Mite tube furnace, which allows a maximum temperature of about 1100° C. The dried and sulfonated polystyrene is carbonized in the tube furnace 212 at an elevated temperature of, for example, about 800° C. at a ramp rate of about 10° C./min and then cooled down to room temperature. The heating and cooling operations are performed under a nitrogen gas (N₂) atmosphere with a N₂ flow rate of, for example, about 40 mL/minute. The heating time is, for example, about 80 minutes, and the cooling time is, for example, about 90 minutes to about 100 minutes, resulting in a total carbonization time of about 3 hours. In an example, 4.5 grams of pristine expanded polystyrene produces about 1.13 grams to about 3.95 grams of the carbon molecular sieve 213, that is, the char yield is 1.13 grams to 3.95 grams carbon at the end of the carbonization process. This example shows the total yield of the carbon molecular sieve 213 obtained from the original raw material, namely, pristine expanded polystyrene, and in an embodiment expanded polystyrene 201.

FIG. 2B illustrates an experimental setup 200b for an embodiment of a process for synthesizing an activated carbon 215 from the carbon molecular sieve 213. The experimental setup 200b comprises, for example, a tube furnace 212, for example, a Lingberg/Blue M™ Mini-Mite tube furnace. The carbon molecular sieve material 213 is synthesized with an acid/expanded polystyrene ratio of, for example, about 1.75. In an embodiment, the carbon molecular sieve 213 is activated with potassium hydroxide (KOH) to enhance its porosity. The carbon molecular sieve 213 is solid-phase mixed 214 with potassium hydroxide. The weight ratios of the carbon molecular sieve 213 to potassium hydroxide are, for example, 1:3, 1:4, and 1:7. In an embodiment as illustrated in FIG. 2B, to activate the carbon molecular sieve 213 with potassium hydroxide, about 1 gram (g) of pristine carbon molecular sieve 213 is mixed with about 3 grams, 4 grams, and 7 grams of solid potassium hydroxide, and each mixture is ground into a fine powder using a grinder, for example, a conventional coffee grinder. Each mixture is then loaded into an alumina boat. The alumina boat is inserted into the same tube furnace 212 used in the synthesis of the carbon molecular sieve 213. The tube furnace 212 is heated, for example, to about 1000° C., at a ramp rate of, for example, about 10° C./min followed by cooling down to room temperature. The heating and cooling operations are performed under nitrogen gas (N₂) with a N₂ flow rate of, for example, about 40 mL/minute. In an embodiment, carbon dioxide is also passed through the tube furnace 212. The volume ration of nitrogen gas and carbon dioxide flowing through the tube furnace 212 is, for example, about 1:1. The heating time is, for example, about 100 minutes, and the cooling time is, for example, about 100 minutes, resulting is a total activation time of about 200 minutes. The resultant activated carbon 215 is washed several times with deionized water, followed by filtration and drying. The activated carbon produced from 3 grams, 4 grams, and 7 grams of potassium hydroxide (KOH) are named, for example, as expanded polystyrene-KOH-1, expanded polystyrene-KOH-2, and expanded polystyrene-KOH-3, respectively. The carbon molecular sieve 213 is characterized by pore textural properties comprising the Brunauer-Emmett-Teller (BET) surface area and pore size distribution as explained in paragraph [0062].

FIG. 2C illustrates an experimental setup 200c for another embodiment of the process for synthesizing an activated carbon 216 from the carbon molecular sieve 213. The experimental setup 200c comprises the tube furnace 212, for example, a Lingberg/Blue M™ Mini-Mite tube furnace. In an embodiment, the carbon molecular sieve 213 is activated with steam to enhance its porosity. To activate the carbon molecular sieve 213 with steam, in an example, about 1 gram (g) of a sample of the carbon molecular sieve 213 is introduced into a porcelain boat and the porcelain boat is inserted into the same tube furnace 212 used in the synthesis of the carbon molecular sieve 213. In this example, a 2-liter (L) Erlenmeyer flask (not shown) is filled with deionized water and placed on a hot plate to bring the water to boil. A rubber hose is connected from the 2L Erlenmeyer flask to a tube 212a in the tube furnace 212, to transfer steam from the 2L Erlenmeyer flask to the tube furnace 212. A nitrogen, CO₂ gas line is connected to the tube 212a through the 2L Erlenmeyer flask through a drilled rubber stopper. The tube furnace 212 is heated, for example, to about 1000° C. at a ramp rate of about 10° C./min under nitrogen gas followed by the mixture of steam and nitrogen gas for a dwell time, for example, of about 90 minutes. At the end of the dwell time, the activated carbon sample is cooled to room temperature under nitrogen gas and used without any further purification. The steam-activated carbon 216 is named, for example, as expanded polystyrene-steam-3.

FIG. 3A illustrates a schematic of the synthesis of a carbon molecular sieve 213 from expanded polystyrene 301. In an embodiment, the expanded polystyrene 301 is pristine expanded polystyrene. In the process disclosed herein, the carbon molecular sieve 213 is synthesized by first sulfonating pristine expanded polystyrene 301 to produce sulfonated polystyrene 302 as disclosed in the descriptions of FIGS. 1A-2A. The sulfonated polystyrene 302 is then carbonized to produce the carbon molecular sieve 213 as disclosed in the descriptions of FIGS. 1A-2A. In the course of the sulfonation reaction, one or more sulfonate groups are attached to phenyl groups or the phenyl ring of the expanded polystyrene molecule as illustrated in FIG. 3A. In an example, 4.5 grams of expanded polystyrene 301 yields about 3.95 grams of a carbon molecular sieve 213.

FIG. 3B illustrates a schematic of the synthesis of an activated carbon 303 from the carbon molecular sieve 213. FIG. 3B illustrates the conversion of the carbon molecular sieve 213 to potassium hydroxide-activated carbons and to steam-activated carbons. The activated carbon 303 is synthesized by activating the synthesized carbon molecular sieve 213 with potassium hydroxide (KOH) or steam as disclosed in the descriptions of FIGS. 2B-2C. In the course of activation, potassium hydroxide or steam react with the carbon to produce nano-sized to micron-sized pores or pits on the carbon surface. These pores increase the porosity, surface area, and pore volume of the activated carbon 303 as illustrated in FIG. 3B. In an example, about 3.95 grams of the carbon molecular sieve 213 yields about 1.18 grams to about 2.76 grams of potassium hydroxide-activated carbon and about 1.97 grams of steam-activated carbon.

Both the sulfonated polystyrene and the carbon molecular sieve are characterized by conventional protocols. The sulfonated polystyrene is examined with thermogravimetric analysis (TGA) under nitrogen gas (N₂) and compared with pristine expanded polystyrene to study the char or carbon yield characteristics. Char or carbon yield refers to an amount of carbon-rich residue that is obtained when a carbonaceous material, for example, pristine expanded polystyrene and/or sulfonated polystyrene, is heated to an elevated temperature under N₂ gas. Char or carbon yield is expressed as weight percent (wt %). The sulfonated and partially pyrolyzed expanded polystyrene at a temperature of up to about 300° C. is also characterized with Fourier transform infrared (FTIR) spectroscopy and X-ray photoelectron spectroscopy (XPS) to study the chemical functionalities. The Fourier transform infrared spectroscopy is performed, for example, using a Nicolet Avatar spectrometer. The X-ray photoelectron spectroscopy is performed, for example, using a spectrometer by Thermo Fisher Scientific, Inc. A few samples of the sulfonated polystyrene are analyzed with pyrolysis gas chromatography (GC) mass spectrometry (MS), abbreviated as Py-GCMS, to determine the identity of evolved gases during pyrolysis that may, in turn, reveal the changes in structural conformation during formation of the carbon molecular sieve. Pyrolysis gas chromatography mass spectrometry is performed, for example, in the Nexis GC-2030 gas chromatograph of Shimadzu Corporation, Japan, with the Shimadzu single quadrupole GCMS-QP2020 NX gas chromatograph-mass spectrometer (GC-MS) for the analysis. The pyrolysis is performed, for example, with the multi-shot pyrolyzer EGA/PY-3030D of Frontier Laboratories Ltd.

The carbon molecular sieve is characterized with pore textural properties comprising the Brunauer-Emmett-Teller (BET) surface area and pore size distribution. The BET surface area is calculated by analyzing nitrogen gas (N₂) adsorption isotherms at 77 Kelvin (K). The pore size distribution is obtained by analyzing nitrogen adsorption isotherms at 77 K and carbon dioxide (CO₂) adsorption isotherms at 273 K. The adsorption isotherms are measured, for example, in the Autosorb-iQ surface area and pore size analyzer of Quantachrome Corporation acquired by Anton Paar Quantatec, Inc. The elemental composition of the carbon molecular sieve is measured, for example, by an X-ray photoelectron spectroscopy (XPS) analyzer. The acquisition time of the X-ray photoelectron spectroscopy data is, for example, about 1 minute and 8 seconds. The X-ray source, spot size, and energy step size are, for example, Al-Kα, 400 micrometers (μm), and 1 electron volt (eV), respectively. The shape, size, and surface morphology of the carbon molecular sieve is studied, for example, by scanning electron microscopy (SEM) and transmission electron microscopy (TEM).

The gas adsorption measurements of the carbon molecular sieve are performed at an ambient temperature of, for example, about 298 K, and a pressure of, for example, up to 1 bar, in the same gas adsorption analyzer, that is, the Autosorb-iQ surface area and pore size analyzer. Five small-molecule gases comprising, for example, carbon dioxide (CO₂), carbon monoxide (CO), methane (CH₄), hydrogen (H₂), and nitrogen gas (N₂) are measured for both equilibrium and kinetics adsorption characteristics. The low-pressure kinetics data are measured in the Autosorb-iQ surface area and pore size analyzer under a “vector dose” mode.

Expanded polystyrene-KOH-3 and expanded polystyrene-steam-3 are chosen as the representatives of potassium hydroxide-activated carbons and steam-activated carbons, respectively, to study water purification and gas separation characteristics. To study the gas separation characteristics, pure-component carbon dioxide (CO₂), methane (CH₄), and nitrogen gas (N₂) adsorption isotherms are measured on the potassium hydroxide (KOH)-activated carbons and the steam-activated carbons followed by calculation of selectivity. The gas adsorption experiments are performed, for example, in the Autosorb-iQ surface area and pore size analyzer. To perform the water purification experiments, five representative pollutants, for example, methylene blue, amoxicillin, tebuthiruon, perfluorooctane sulfonic acid (PFOS), and lead are employed. In the water purification studies, for example, about 25 mL 1 part per million (ppm) of each of the model pollutants is contacted with about 25 milligrams (mg) of expanded polystyrene-KOH-3 and expanded polystyrene-steam-3 by shaking them in an orbital shaker overnight. The carbons are then separated by filtration, and concentrations of the remaining pollutants are measured. The concentration of methylene blue is measured, for example, by ultraviolet visible (UV-Vis) spectroscopy. The concentration of perfluorooctane sulfonic acid is measured, for example, by liquid chromatography-mass spectrometry (LC-MS). The concentration of lead is measured, for example, by atomic absorption spectroscopy (AAS). The amount adsorbed or removed in the course of the study is measured by difference in concentration.

FIG. 4A illustrates a graphical representation showing a thermogravimetric analysis (TGA) of modified expanded polystyrene. FIG. 4B illustrates a graphical representation showing a derivative of the thermogravimetric analysis plot shown in FIG. 4A, where an inset plot shows pristine expanded polystyrene. The line referenced by the numeral 401 in FIG. 4B indicates pristine expanded polystyrene in the inset plot, and the lines referenced by the numerals 402, 403, 404, 405, and 406 in FIG. 4B indicate acid/expanded polystyrene (A/E) ratios of 0.44 mL/g, 0.88 mL/g, 1.75 mL/g. 2.52 mL/g, and 3.61 mL/g, respectively. As illustrated in FIG. 4A, the pristine expanded polystyrene loses mass drastically around 400° C. with no carbon or char residue. The loss of mass by the pristine expanded polystyrene is manifested as a large d-TGA peak in the inset plot illustrated in FIG. 4B. The thermogravimetric analysis demonstrates a major shift in terms of char residue and derivative peaks with the sulfonation of expanded polystyrene in various ratios. When the A/E ratio is 0.44, a new d-TGA peak appears at around 160° C. along with a diminishing previous peak at 400° C. and gaining the mass residue from 0.0 to about 19.1%. With the increase in the A/E ratio from 0.88 to 2.52, three more d-TGA peaks appear at 165° C., 245° C., and 306° C. The original d-TGA peak at 400° C. completely disappears for an A/E ratio of 1.75 and 2.52. At the highest A/E ratio of 3.61, the char yield drastically decreases with the reappearance of a large d-TGA peak at 400° C. This observation clearly indicates a difference in the mechanism of carbonization in pristine and sulfonated polystyrene with different A/E ratios. FIG. 4C illustrates a graphical representation showing a percent of carbon yield as a function of the A/E ratio. The carbon or char yield as a function of sulfonation, that is, the A/E ratio, is illustrated in FIG. 4C. As illustrated in FIG. 4C, the char yield increases with the increase in the A/E ratio and the highest char yield occurs at about A/E=0.88. There forms almost a plateau up to the A/E ratio of 2.52 with only a minor decrease in the char yield. At A/E=3.61, the char yield drastically decreases to about 9.3 wt. %.

The char value of the sulfonated polystyrene is determined when the sulfonated polystyrene is carbonized in step 102 disclosed in the description of FIG. 1A. The unit of char value is weight percent (wt %). The numeric value for char or carbon yield of pure expanded polystyrene is zero, and the numeric value for char yield of sulfonated polystyrene can be obtained from FIG. 4C. Char value, or char yield, or carbon yield is the amount of char or carbon that is obtained in the course of carbonization, that is, heating of the dried and sulfonated polystyrene at 800° C. under nitrogen gas (N₂). Paragraph shows a comparison. Pristine expanded polystyrene has no “char yield” which means that if the pristine expanded polystyrene is heated to 800° C. under N₂, no carbon or char will be produced, and therefore, no carbon-based materials such as a carbon molecular sieve or an activated carbon can be produced from pristine expanded polystyrene. If the sulfonated polystyrene is heated under the same condition, the sulfonated polystyrene will produce the char which is the carbon molecular sieve, and which can thereafter be converted to an activated carbon. Unlike pristine expanded polystyrene or in an embodiment, expanded polystyrene, sulfonated polystyrene has a char yield. The process for sulfonating the expanded polystyrene disclosed in the descriptions of FIGS. 1A-1B does not produce char. The process for synthesizing the carbon molecular sieve disclosed in the descriptions of FIGS. 1A-1B produces char which is the carbon molecular sieve, when the sulfonated polystyrene is heated to 800° C. under N₂. If a material has no char value, for example, pristine expanded polystyrene, then that material will not produce any carbon or char in the process of carbonization. It means that no carbonaceous material, for example, a carbon molecular sieve or an activated carbon, can be produced from that pristine expanded polystyrene. If a material does have a char value, for example, sulfonated polystyrene, the material will produce char or carbon upon heating, and thereafter produce the carbon molecular sieve and the activated carbon.

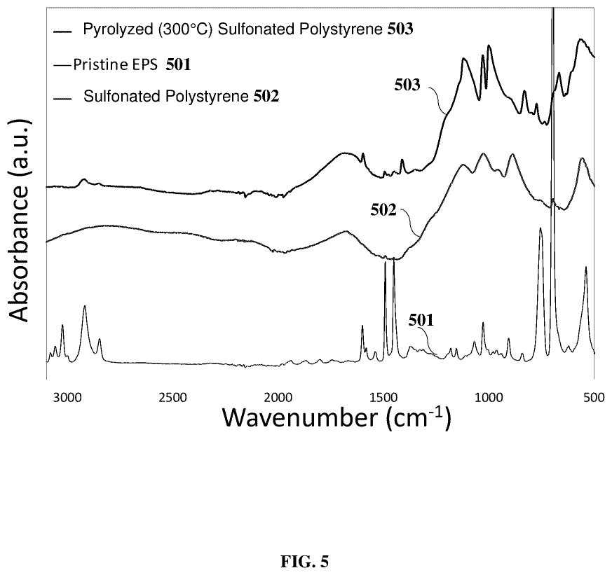

FIG. 5 illustrates a graphical representation showing Fourier transform infrared (FTIR) data of pristine expanded polystyrene, sulfonated polystyrene with an acid/expanded polystyrene (A/E) ratio of 1.75 mL/g, and partially sulfonated and partially pyrolyzed polystyrene at 300° C. The lines referenced by the numerals 501, 502, and 503 in FIG. 5 indicate pristine expanded polystyrene, sulfonated polystyrene, and pyrolyzed polystyrene at 300° C., respectively. The FTIR data of pristine expanded polystyrene is the same as that of other expanded polystyrene materials known in the art. The two largest characteristic peaks at ˜693 cm⁻¹ and 754 cm⁻¹ are caused by aromatic ring out-of-plane vibrations and carbon hydrogen (CH) out-of-plane vibrations, respectively. The three strong peaks at ˜1447 cm⁻¹, 1485 cm⁻¹, and 1600 cm⁻¹ belong to the aromatic ring stretching vibrations. Two peaks at 2900 cm⁻¹ and 2850 cm⁻¹ are attributed to the aliphatic-CH deformation vibrations of an expanded polystyrene macromolecule. The small peaks in 3100-300 cm⁻¹ regions belong to olefinic ═C—H stretching vibrations. The peak pattern in the sulfonated polystyrene is completely changed. The two broad peaks at ˜ 1020 cm⁻¹ and 1121 cm⁻¹ belong to sulfonic acid (—SO₃H) functionality. The peak ˜883 cm⁻¹ may be caused by the S—OH stretching of HSO₄⁻ group. On analyzing the FTIR data of partially pyrolyzed sulfonated polystyrene, a few more new peaks are observed that may provide more light on the transformation of the sulfonated polystyrene to a carbon molecular sieve.

The peak at 883 cm⁻¹ in the sulfonated polystyrene disappears; instead, a new peak appears at 660 cm⁻¹. This peak along with two other peaks at ˜1020 cm⁻¹ and 1121 cm⁻¹, that were transferred from the sulfonated polystyrene, still belongs to the sulfonic acid (—SO₃H) functionality. The peak at 829 cm⁻¹ may be attributed to the —CH₂SH group whereas the two peaks at 735 cm⁻¹ and 771 cm⁻¹ may belong to a mono-substituted benzene ring. Four small peaks at ˜ 1408 cm⁻¹, 1444 cm⁻¹, 1471 cm⁻¹, 1492 cm⁻¹, and 2917 cm⁻¹ may provide the signature of alkyl sulfur species, similar to —CH₂—S— or —CH₃CH₂—S—. The presence of these groups may corroborate the inter/intra chain crosslinking of sulfonated polystyrene in the course of pyrolysis, which converts into a pure carbon matrix at the elevated temperature. Such possible transformation is also supported by the results of pyrolysis gas chromatography (GC) mass spectrometry (MS), abbreviated as Py-GCMS, disclosed below.

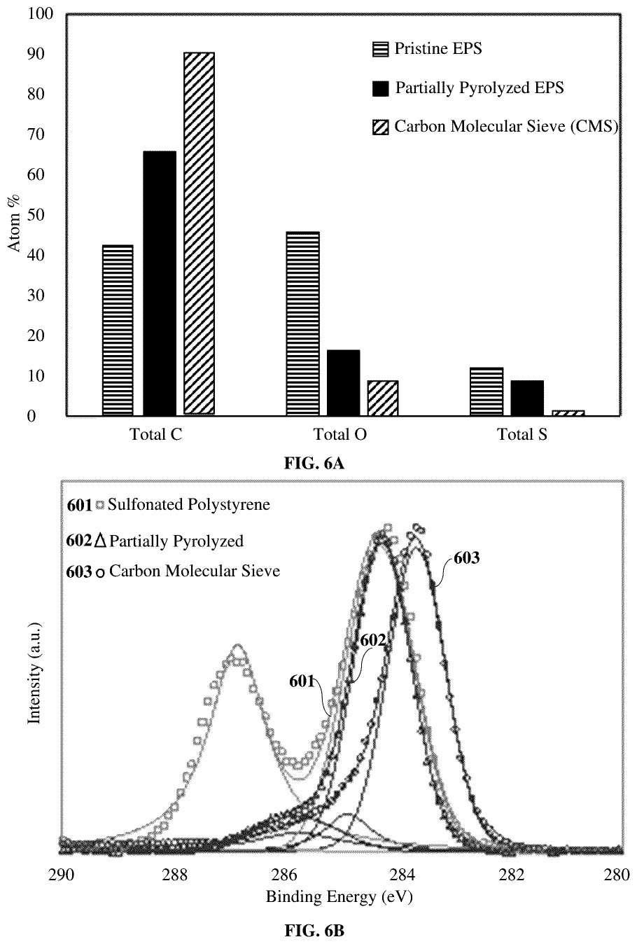

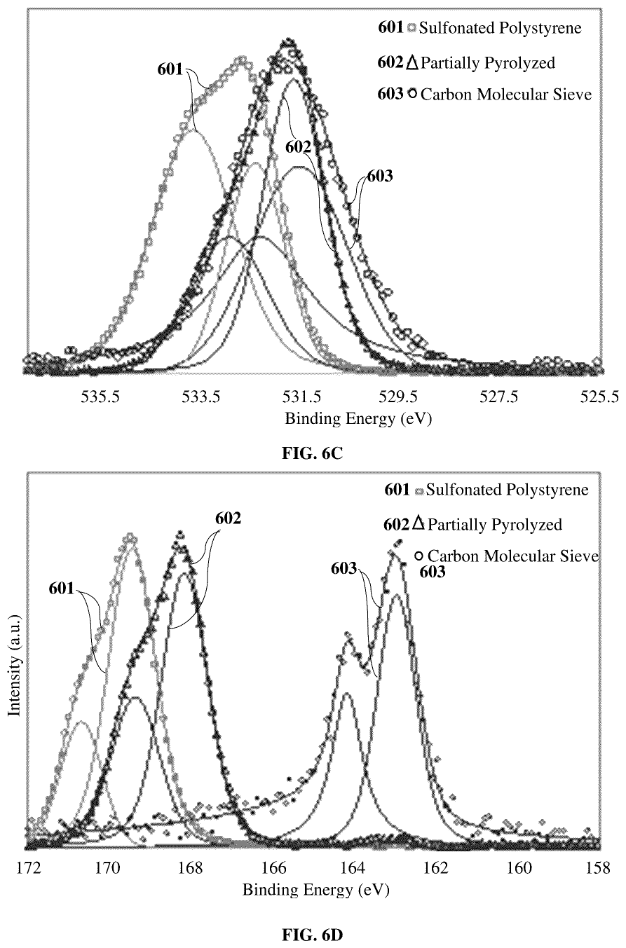

FIG. 6A illustrates a graphical representation showing transformation of carbon, oxygen, and sulfur from sulfonated polystyrene to a carbon molecular sieve. FIGS. 6B-6D illustrate graphical representations showing C-1s peak spectra, O-1s peak spectra, and S-2p peak spectra, respectively, in the sulfonated polystyrene, partially pyrolyzed expanded polystyrene, and the carbon molecular sieve. The lines referenced by the numerals 601, 602, and 603 in FIGS. 6B-6D indicate sulfonated polystyrene, partially pyrolyzed expanded polystyrene, and the carbon molecular sieve, respectively. The X-ray photoelectron spectroscopy (XPS) data of C-1s, O-1s, and S-2p for a representative sulfonated polystyrene with an acid/expanded polystyrene (A/E) ratio of 1.75 mL/g is shown in FIG. 6A and the corresponding peaks are shown in FIGS. 6B-6D.

To understand the transformation of the sulfonated polystyrene to the carbon molecular sieve, the X-ray photoelectron spectra for carbon (C), oxygen (O), and sulfur(S) are captured for the sulfonated polystyrene with the A/E ratio of 1.75 mL/g, the partially pyrolyzed expanded polystyrene at 300° C., and the carbon molecular sieve. As illustrated in FIG. 6A, the total carbon contents increased from 42.6 atom % to 90.1 atom % from the sulfonated polystyrene to the carbon molecular sieve confirming that the carbon molecular sieve is primarily a carbon material. The other two heteroatoms, O and S, decreased from the sulfonated polystyrene to the carbon molecular sieve, which is also intuitive of the carbonization process. The smallest amount of heteroatom that is present in the carbon molecular sieve is sulfur which is, 1.46 atom %.

The transformation of the C-1s peak patterns from the sulfonated polystyrene to the carbon molecular sieve is illustrated in FIG. 6B. There are two sharp peaks in the C-1s spectra around 284.3 electron volts (eV) and 287 eV for the sulfonated polystyrene, that are very distinctive compared to that of other species. The peak at 284.3 eV may belong to the C═C structure of the aromatic ring, that is, the phenyl group, of the expanded polystyrene molecule, whereas the peak at 287 eV may belong to C—O structure or C═O—C/COOH. Presence of bound oxygen with carbon indicates that part of the expanded polystyrene may be oxidized in the course of sulfonation. In the carbon molecular sieve structure, the largest peak at around 284.5 eV corresponds to sp² hybridized carbon. The presence of sp³ hybridized carbon as defects and C—O functionalities are observed in the carbon molecular sieve. There is a substantially distinctive change in S-2p peaks for the carbon molecular sieve compared to other two species as illustrated in FIG. 6D. For pristine sulfonated polystyrene, the two possible peaks are located at around 169.38 eV and 170.68 eV. The first peak is associated with the sulfonated phenyl ring of the expanded polystyrene molecule, whereas the second peak may be attributed to the sulfate group. For the partially pyrolyzed and sulfonated polystyrene, the peak at 169.38 eV remains intact, whereas, a new peak appears at around 168.28 eV. The continuing existence of the peak at 169.38 eV suggests that part of the sulfonic acid groups may remain intact. Most likely, the new peak at 168.28 eV suggests the presence of sulfonyl bridges (—(SO₂)—) between two adjacent phenyl groups. In the carbon molecular sieve material that is synthesized by carbonizing the sulfonated polymer at 900° C., two distinct peaks forming S-2p have been observed. The peak 164.18 eV may be attributed to the sulfur bridges (—S—) that are originated from sulfonate bridges upon carbonization. The peak at around 163 eV may be attributed to the C—S/C—S—C bonds. Such spectra of sulfur also support the findings from the Fourier transform infrared (FTIR) spectra. The transformation of the O-1s peak patterns from the sulfonated polystyrene to the carbon molecular sieve is illustrated in FIG. 6C. There are large peaks in the higher binding energy levels of oxygen which causes an apparent shift in peak position of the sulfonated and partially pyrolyzed/sulfonated polystyrene compared to that of the carbon molecular sieve. The peak at around 533 eV for the sulfonated polystyrene may be attributed to an organic C—O or C—O—H group that supports the binding of oxygen with carbon in the course of sulfonation. For the same species, the peak at 532.5 eV may attributed to organic C—O functionalities. In the partially pyrolyzed species, the peak at 532.5 eV still remains possibly indicating the presence of a C═O group. The peak at 531.5 eV in the partially pyrolyzed expanded polystyrene or the carbon molecular sieve may belong to the C—O or C—OH group.

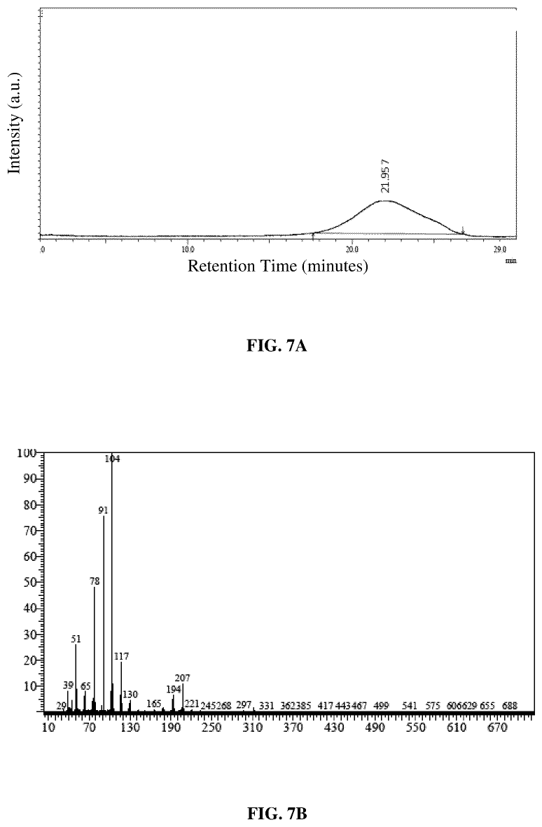

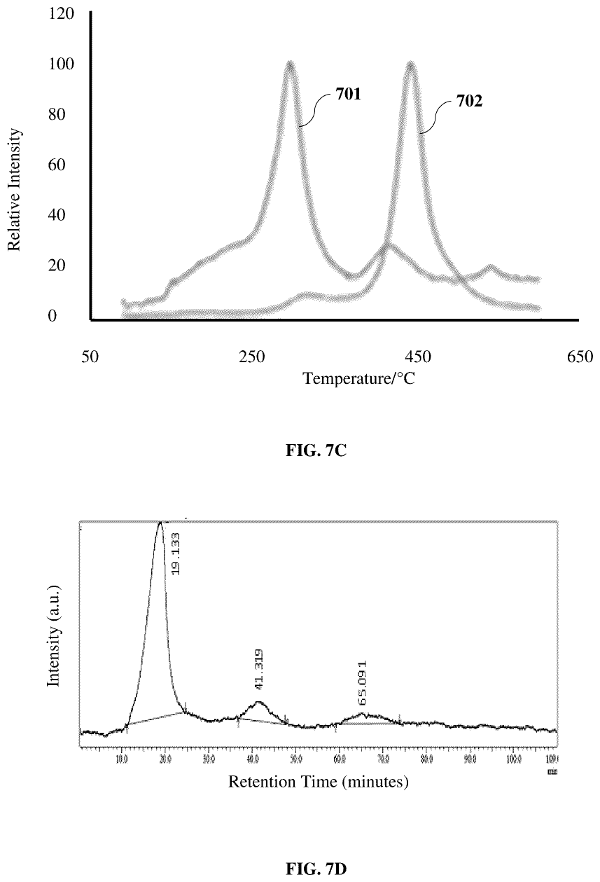

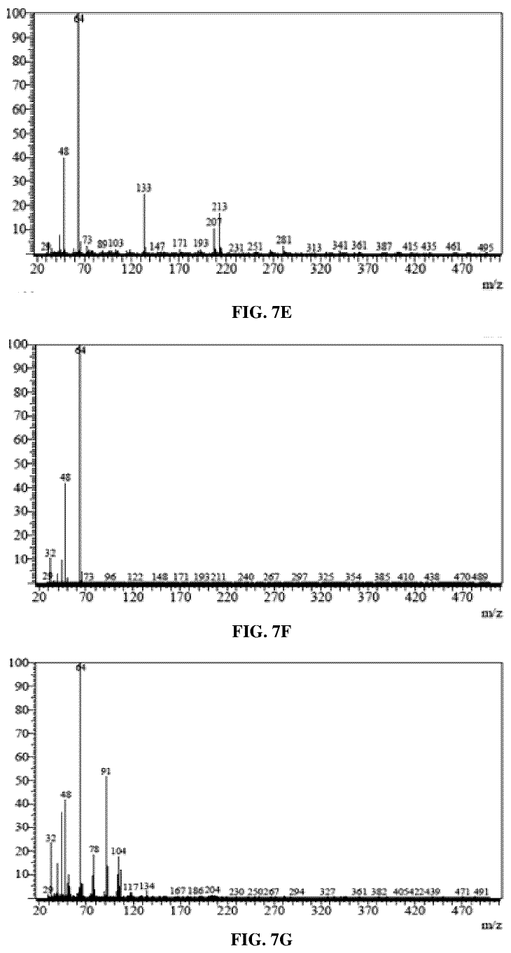

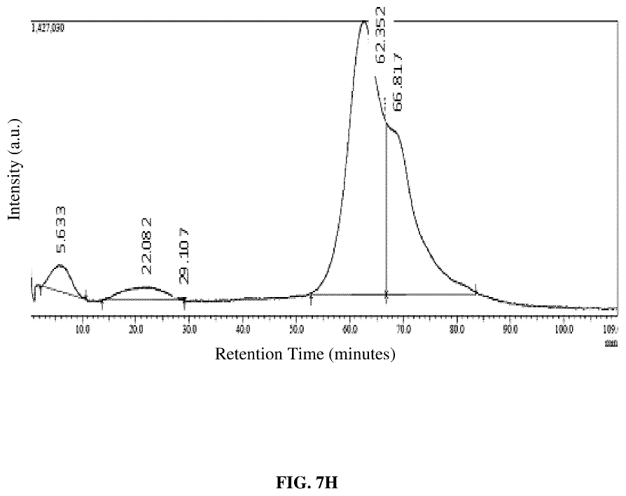

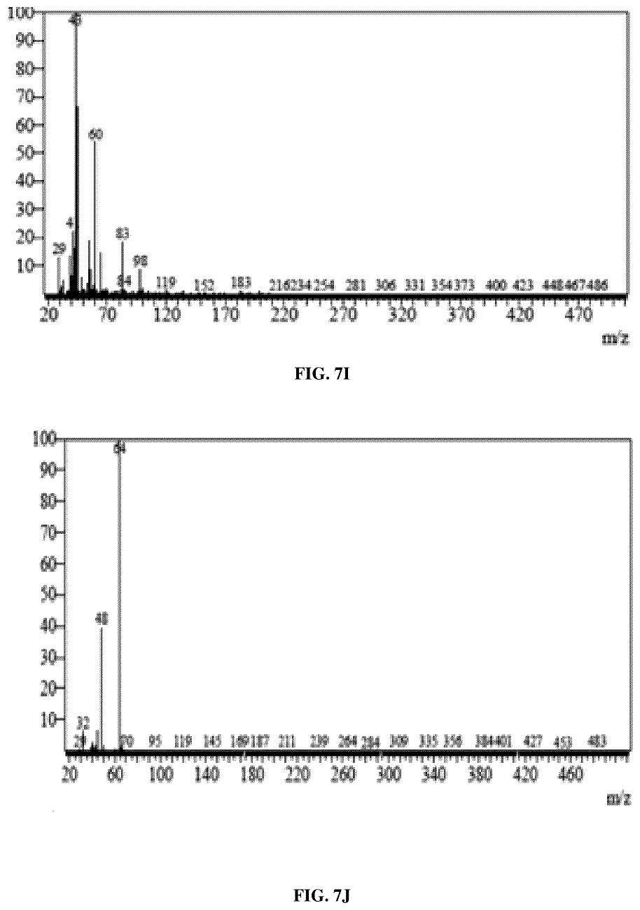

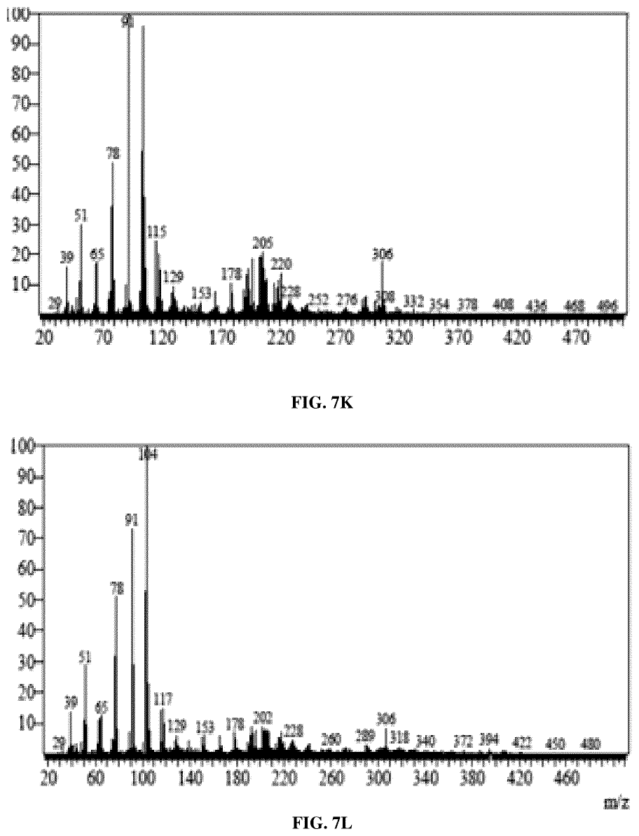

FIGS. 7A-7B illustrate a total ion chromatogram (TIC) of pristine expanded polystyrene and the corresponding mass spectrum for evolved gas analysis of the pristine expanded polystyrene at 21.95 minutes, respectively. The key mass/charge number (m/z) components for the decomposition of expanded polystyrene are 104, 91, 78, 51, and 117. In an embodiment, the species with m/z of 104, 91, and 78 may represent styrene, that is, a monomer; a fragment of toluene; and benzene, respectively, which are the key decomposition products of expanded polystyrene. In another embodiment, the species with m/z of 51 and 117 may represent fragmented components of a benzene ring and an expanded polystyrene polymer itself.

FIG. 7C illustrates a graphical representation showing evolved gas intensity for an acid/expanded polystyrene (A/E) ratio of 1.75 and an A/E ratio of 3.61. The lines referenced by the numerals 701 and 702 in FIG. 7C indicate the evolved gas analyzed peaks for the A/E ratio of 1.75 and the A/E ratio of 3.61, respectively. The large gas concentration peak for the A/E ratio of 1.75 appears at a lower temperature compared to that of the A/E ratio of 3.61 that supports the thermogravimetric analysis (TGA) studies.

FIG. 7D illustrates a total ion chromatogram of an acid/expanded polystyrene (A/E) ratio of 1.75. For the A/E ratio of 1.75, the total ion chromatogram shows three peaks at times 19.13 minutes, 41.31 minutes, and 65.09 minutes as illustrated in FIG. 7D. FIGS. 7E-7G illustrate mass spectra of the A/E ratio of 1.75 at 19.13 minutes, 41.31 minutes, and 65.09 minutes, respectively. In the mass spectra of the first two times, that is, 19.13 minutes and 41.31 minutes as illustrated in FIGS. 7E-7F, respectively, the key evolved gas is sulfur dioxide (SO₂) which represents m/z of 64 and 48, indicating that majority of the sulfonate groups broke down as sulfur dioxide in the course of carbonization. In the third time of 65.09 minutes illustrated in FIG. 7G, sulfur dioxide continued to evolve along with decomposition of the main expanded polystyrene skeletal structure. All the fragments of pristine expanded polystyrene are observed except m/z of 5, along with an additional m/z of 32, probably indicating oxygen. The intensities of those fragments are lower and different compared to that of pure expanded polystyrene corroborating the char yielding behavior of the A/E ratio of 1.75. Pristine expanded polystyrene is observed to not have any char yield.

FIG. 7H illustrates a total ion chromatogram of an acid/expanded polystyrene (A/E) ratio of 3.61. The total ion chromatogram of the A/E ratio of 3.61 shows four peaks at times 5.63 minutes, 22.08 minutes, 62.53 minutes, and 66.81 minutes as illustrated in FIG. 7H. FIGS. 7I-7L illustrate mass spectra of the A/E ratio of 3.61 at 5.63 minutes, 22.08 minutes, 62.53 minutes, and 66.81 minutes, respectively. The mass spectra for the first two times, that is, 5.63 minutes and 22.08 minutes, show sulfur dioxide (SO₂) as the primary constituent of the evolved gas, which is similar to that of the previous sample. At the third time, that is, 62.53 minutes, the skeletal structure of expanded polystyrene starts to break down as the evidence of benzene (78) and the fragment of toluene (91) along with several other fragments. At the fourth time, that is, 66.81 minutes, more evidence of the breakdown of expanded polystyrene is observed with the presence of styrene (104). Relative intensities of those fragments parted increased along new fragments, which may corroborate the lower char yield of the A/E ratio of 3.61 compared to that of the A/E ratio of 1.75, and the resemblance of the thermogravimetric analysis (TGA) pattern of the A/E ratio of 3.61 with that of pristine expanded polystyrene. It is also observed that the carbonization of this expanded polystyrene does not contribute to the emission of any carbon dioxide (CO₂) and hence may not contribute to global warming.

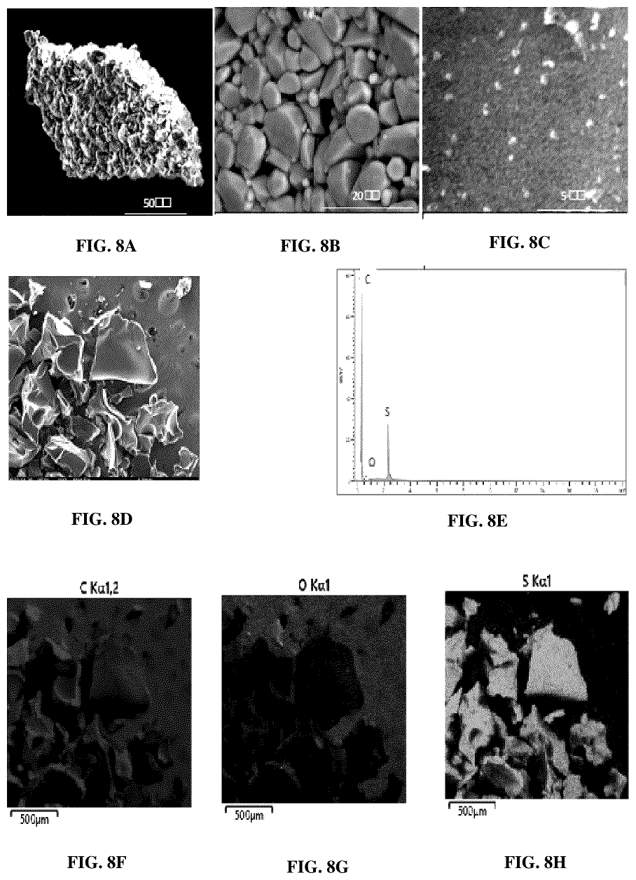

FIGS. 8A-8H illustrate representative scanning electron microscopy (SEM) images of sulfonated polystyrene with an acid/expanded polystyrene (A/E) ratio of 1.75 mL/g. The SEM imaging and the energy dispersive X-ray (EDX) mapping of the A/E ratio of 1.7 m⁵ mL/g as a representative a carbon molecular sieve are illustrated in FIGS. 8A-8H. FIGS. 8A-8C illustrate that the particles are completely heterogeneous in shape and size; the size varies from 2 micrometers (μm) to 50 μm. The EDX confirms the presence of carbon (C), oxygen (O), and sulfur(S) in the carbon material whereas the mapping illustrated in FIGS. 8F-8H confirms that these elements, that is, carbon (C), oxygen (O), and sulfur, are homogenously distributed.

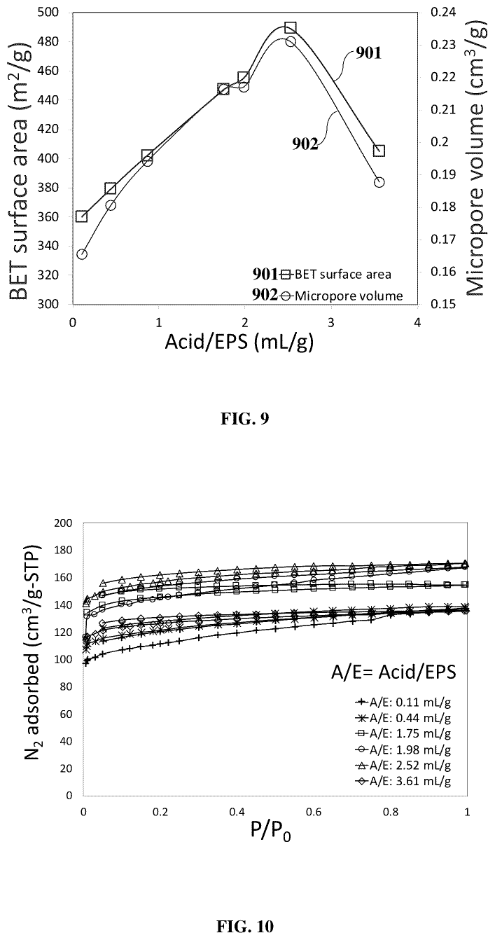

FIG. 9 illustrates a graphical representation showing a correlation of a Brunauer-Emmett-Teller (BET) surface area and micropore volume with the acid/expanded polystyrene (A/E) ratio. The lines referenced by the numerals 901 and 902 in FIG. 9 indicate the BET surface area and the micropore volume, respectively. The pore textural properties of the carbon molecular sieves comprise BET specific surface areas (BET SSA), pore volume, and the pore size distributions. The BET surface area, micropore, and mesopore volume are provided in Table 1 below.

TABLE 1
Pore textural properties of the carbon molecular sieve (CMS)

| | BET SSA | Micropore | Total volume |
|---|---|---|---|
| Sample ID | (m²/g) | volume (cm³/g) | (cm³/g) |
| A/E: 0.11 mL/g | 360 | 0.16 | 0.19 |
| A/E: 0.44 mL/g | 379 | 0.18 | 0.19 |
| A/E: 1.75 mL/g | 447 | 0.21 | 0.21 |
| A/E: 1.98 mL/g | 455 | 0.22 | 0.23 |
| A/E: 2.52 mL/g | 489 | 0.23 | 0.24 |
| A/E: 3.61 mL/g | 405 | 0.18 | 0.19 |

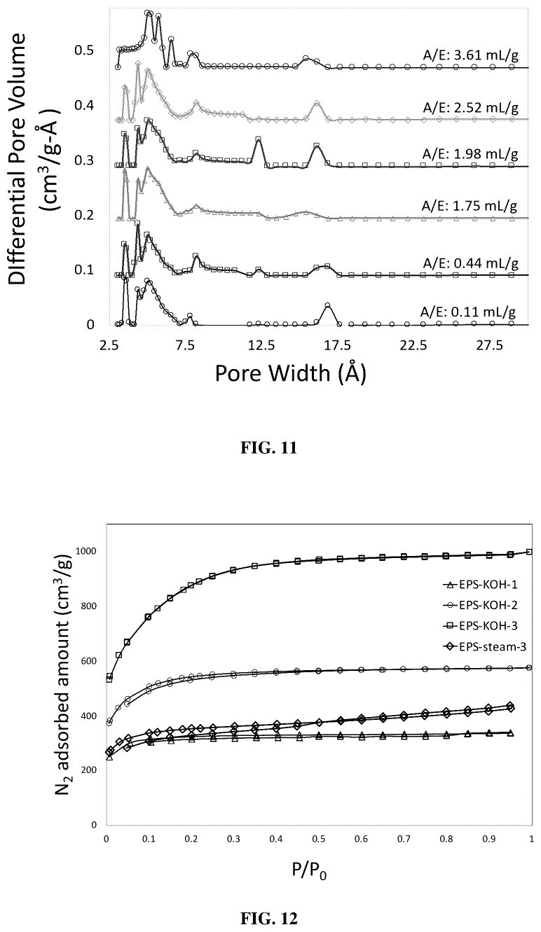

The highest BET SSA, that is, 489 square meters per gram (m²/g), and the highest pore volume, that is, 0.24 cubic centimeters per gram (cm³/g), belong to the sample A/E: 2.52 mL/g. Table 1 above confirms that the carbon molecular sieve is primarily a microporous carbon with a negligible mesopore volume. The correlation of the BET SSA and the micropore volume as a function of the acid/expanded polystyrene (A/E) ratio is illustrated in FIG. 9. As illustrated in FIG. 9, both the BET SSA and the micropore volume increase monotonically with the A/E ratio up to 2.52 mL/g, and after that the BET SSA and the micropore volume demonstrate a decreasing trend. The non-local density functional theory (NLDFT)-based pore size distribution is obtained by analyzing both nitrogen gas (N₂) adsorption isotherms at 77 Kelvin (K) and carbon dioxide (CO₂) adsorption isotherms at 273 K. The pore size below 10 angstroms (Å) is obtained from the carbon dioxide adsorption isotherms whereas the pore size above 10 Å is obtained from the nitrogen adsorption isotherms. Nitrogen gas (N₂) adsorption-desorption plots at 77K for carbon molecular sieves produced from sulfonated polystyrene are illustrated in FIG. 10.

FIG. 11 illustrates a graphical representation showing pore size distribution obtained by a non-local density functional theory (NLDFT) analysis. The combined pore size distribution plot is illustrated in FIG. 11 for the carbon molecular sieves. As illustrated in FIG. 11, all the carbon molecular sieve materials have narrow pores within 3.49 angstroms (Å) to 8.21 Å. The pore at 3.49 Å is attributed to graphite layer spacings and hence is not a true pore. The other narrow pores within this region are 4.37 Å and 5.0 Å. The sample with the acid/expanded polystyrene (A/E) ratio of 3.61 mL/g has a couple of additional pores in this region, 5.73 Å and 6.5 Å. In the larger micropore region, all the carbon molecular sieve materials have the pores in 16.13 Å. The sample A/E: 2.52 mL/g has an additional larger pore at 12.31 Å. For the sample of A/E: 1.75 mL/g, the larger micropores are negligible and comprise primarily micropores.

In the course of synthesis of the carbon molecular sieve or the carbon molecular sieve-derived activated carbons, varieties of metallic entities, for example, palladium (Pd), platinum (Pt), ruthenium (Ru), iron (Fe), copper (Cu), etc., can be doped from their suitable precursors. Pd, Pt, and Ru-doped carbons can be used as a catalyst, like in hydrogenation reactions of organic materials, electrocatalysis, anode catalysis of fuel cells, hydrosilylation, oxidation of alcohols, etc. Furthermore, the surfactant-based mesoporous carbon can also be produced by mixing the sulfonated polystyrene with a block copolymer, for example, Pluronic® P123, Pluronic® F127, etc., or ionic surfactants, for example, cetrimonium bromide (CTAB), followed by carbonization.

The pore textural properties of potassium hydroxide (KOH)-activated carbons and steam-activated carbons are provided in Table 2 below and the corresponding nitrogen gas (N₂) adsorption-desorption plots at 77 Kelvin (K) are illustrated in FIG. 12 for the activated carbons produced by potassium hydroxide activation and steam activation.

TABLE 2
Pore textural properties of activated carbons

| | BET SSA | Micropore | Total volume |
|---|---|---|---|
| Sample ID | (m²/g) | volume (cm³/g) | (cm³/g) |
| EPS-KOH-1 | 994 | 0.45 | 0.45 |
| EPS-KOH-2 | 1885 | 0.69 | 0.8 |
| EPS-KOH-3 | 3039 | 1.06 | 1.38 |
| EPS-Steam-3 | 1150 | 0.42 | 0.61 |

Table 2 above illustrates that potassium hydroxide activation produces much higher porosity than activation by steam. As the carbon to potassium hydroxide ratio increases from 1:3 to 1:7, the surface area and the pore volume increase monotonically. The highest Brunauer-Emmett-Teller (BET) surface area is 3039 m²/g., which exceeds the BET surface area of activated carbons known in the art.

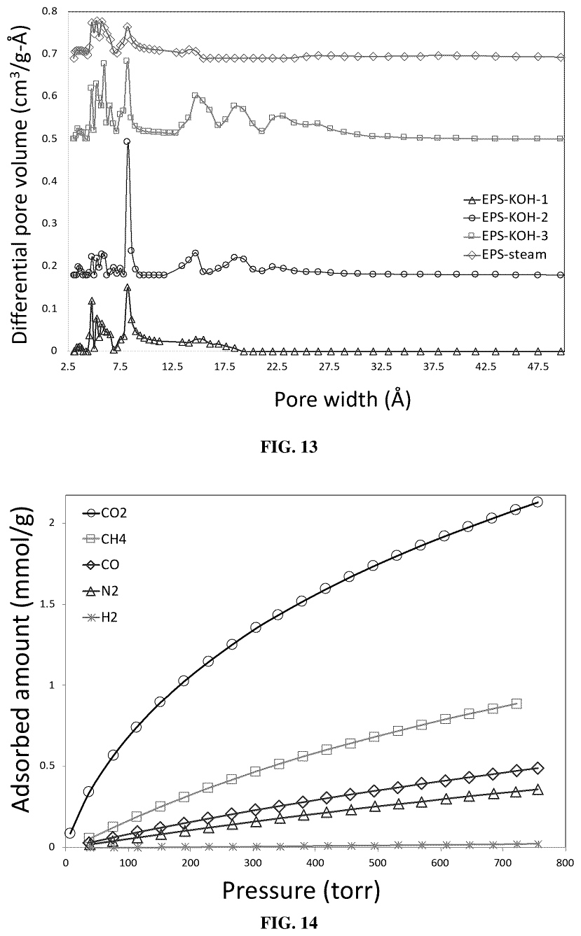

FIG. 13 illustrates a graphical representation showing pore size distribution of potassium hydroxide-activated carbons and steam-activated carbons. The non-local density functional theory (NLDFT)-based pore size distribution of potassium hydroxide (KOH)-activated carbons and steam-activated carbons are illustrated in FIG. 13. As illustrated in FIG. 13, a majority of the pores are associated in the microporous region (<20 Å). A few supermicropores are created in all the activated carbons. Expanded polystyrene (EPS)-KOH-3 has the largest number of pores. Expanded polystyrene-KOH-3 is observed to be generated with a larger volume of ultramicropores, including mesopores that contribute to its higher mesoporosity. Steam-activated carbon, that is, expanded polystyrene-steam-3, has a minimum volume of larger pores.

TABLE 3
Atomic contents of two representative activated carbons

| Sample ID | C (atom %) | O (atom %) | S (atom %) |
|---|---|---|---|
| EPS-KOH-3 | 75.02 | 23.97 | 1.01 |
| EPS-Steam-3 | 88.23 | 11.16 | 0.61 |

Table 3 above illustrates the atomic contents of two representative activated carbons, EPS-KOH-3 and EPS-steam-3, as measured by X-ray photoelectron spectroscopy (XPS). As illustrated in Table 3, the steam-activated carbon results in larger carbon contents of about 88.23 atom % compared to that of the potassium hydroxide (KOH)-activated carbon of about 75.02 atom %. The potassium-hydroxide-activated carbon results in substantially larger oxygen contents of about 23.97 atom % compared to that of the steam-activated carbon which is about 11.16 atom %. Sulfur contents are more reduced by steam activation compared to that of potassium hydroxide activation. Detailed percentages of carbon and other associated elements, namely, sulfur and oxygen, are provided in Table 3 above.

FIG. 14 illustrates a graphical representation showing adsorption isotherms of small-molecule gases on an acid/expanded polystyrene (A/E) ratio of 1.75 mL/g at 298 Kelvin (K). The adsorption isotherms of carbon dioxide (CO₂), methane (CH₄), carbon monoxide (CO), nitrogen gas (N₂), and hydrogen gas (H₂) at 298 K and pressure up to about 1 bar on A/E: 1.75 is illustrated in FIG. 14. The CO₂ adsorbed amount of about 2.12 millimoles per gram (mmol/g) is the highest among the gases. The CO₂ adsorbed amount is followed by methane and nitrogen gas. The smallest adsorption isotherm belonged to hydrogen gas. This trend of equilibrium gas adsorption capacity is similar to the other porous carbon-based materials.

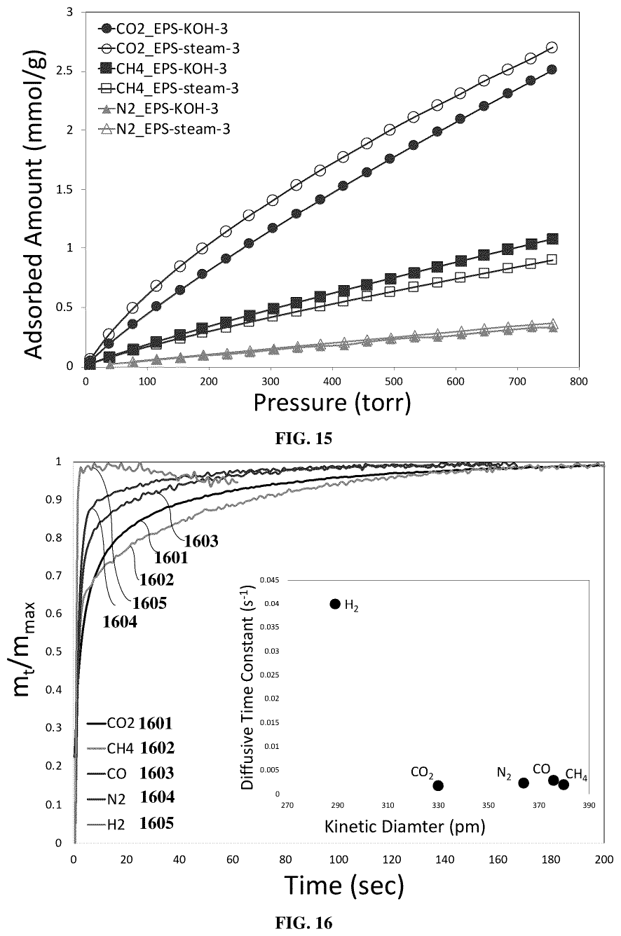

FIG. 15 illustrates a graphical representation showing adsorption isotherms of carbon dioxide (CO₂), methane (CH₄), and nitrogen gas (N₂) on expanded polystyrene (EPS)-potassium hydroxide (KOH)-3 and expanded polystyrene-steam-3 at 298 Kelvin (K). The adsorbed amount of carbon dioxide is typically greater than methane, followed by nitrogen gas, which is common for all carbon-based materials. Expanded polystyrene-KOH-3 possesses a higher surface area and pore volume compared to that of expanded polystyrene-steam-3, which is reflected in methane and nitrogen gas adsorbed amounts. The adsorbed amount of carbon dioxide for expanded polystyrene-steam-3 is higher than that of expanded polystyrene-KOH-3. This anomaly is due to the basic/alkaline surface functionalities that may be formed by steam activation.

FIG. 16 illustrates a graphical representation showing low-pressure adsorption kinetics of gases on an acid/expanded polystyrene (A/E) ratio of 1.75 mL/g at 298 Kelvin (K), where an inset plot shows a correlation of diffusive time constants with a kinetic diameter. The lines referenced by the numerals 1601, 1602, 1603, 1604, and 1605 in FIG. 16 indicate carbon dioxide (CO₂), methane (CH₄), carbon monoxide (CO), nitrogen gas (N₂), and hydrogen gas (H₂), respectively. As illustrated in FIG. 16, the fastest adsorbing species is hydrogen gas, which reaches saturation within 3.5 seconds. The saturation times of nitrogen gas and carbon monoxide were about the same, that is, about 100 seconds. The slowest adsorbing species are carbon dioxide and methane, which takes about 160 seconds to saturate. Since the carbon molecular sieve primarily comprises micropores, a micropore diffusion model is applied to kinetic curves, as follows:

$$\frac{q}{{q}_{e}} = 1 - \frac{6}{{π}^{2}} {\sum }_{n = 1}^{n = ∞} \frac{1}{{n}^{2}} exp ( \frac{{n}^{2} {π}^{2} {D}_{c} t}{{r}_{c}^{2}} )$$

where q(t) is the adsorbed amount at time t, qₑ is the saturated adsorbed amount, D_{c} is the intracrystalline diffusivity, and r_{c} is the intracrystalline radius. By model fitting the adsorption kinetics data with the first term of the summation only, the resultant equation becomes:

$$\frac{q}{{q}_{e}} = 1 - \frac{6}{{π}^{2}} exp ( \frac{{n}^{2} {π}^{2} {D}_{c} t}{{r}_{c}^{2}} )$$

In an embodiment, the diffusive time constant (D_{c}/r_{c}², s⁻¹) is calculated by a linear regression of a logarithmic form of the equation within about 75% to about 99% of the saturation level. The diffusive time constant as a function of the kinetic diameter of the gases is illustrated in the inset plot of FIG. 16. It is observed that hydrogen gas (H₂) that has the smallest kinetic diameter of about 289 picometer (pm), demonstrates the fastest diffusive time constant of 0.0398 s⁻¹. The value of diffusive time of carbon dioxide (CO₂) decreases one order of magnitude compared to that hydrogen gas. For carbon dioxide, nitrogen gas, and carbon monoxide, there is an increase in the kinetic diameter, but the diffusive time constants demonstrate a slightly increased value, where the diffusive time constant: CO>N₂>CO₂. Such a small anomaly may be caused by partial blocking of the narrow pores with the elevated adsorption amount, where the adsorbed amount: CO₂>CO>N₂. The smallest diffusive constant, for example, 0.00189 s⁻¹, is demonstrated by methane that has the largest kinetic diameter of about 380 pm.

Separation of specific gases from one component to another is required for multiple applications and therefore, separation of those gases is of high industrial significance. Separation of methane (CH₄) from carbon dioxide (CO₂) and nitrogen gas (N₂) is required for natural gas purification. Separation of carbon monoxide (CO) and hydrogen gas (H₂) is required for water gas separations. Separation of nitrogen gas (N₂) from hydrogen gas (H₂) is industrially required for ammonia synthesis purposes. Since performing mixed gas adsorption is challenging, the pure, single-component, gas adsorption isotherm is measured and the selectivity values are reported. For the binary components, the selectivity (½) of component 1, that is, the preferred gas, over component 2, that is, the non-preferred gas, is defined as follows:

$${{}_{}}_{1 / 2} = \frac{{x}_{1} / {y}_{1}}{{x}_{2} / {y}_{2}}$$

where x and y are the mole fractions of adsorbate in an adsorbed phase and a bulk gas phase, respectively. In an embodiment, selectivity is calculated from adsorption isotherms by the ideally adsorbed solution theory (IAST), originally proposed by Myers and Prausnitz.

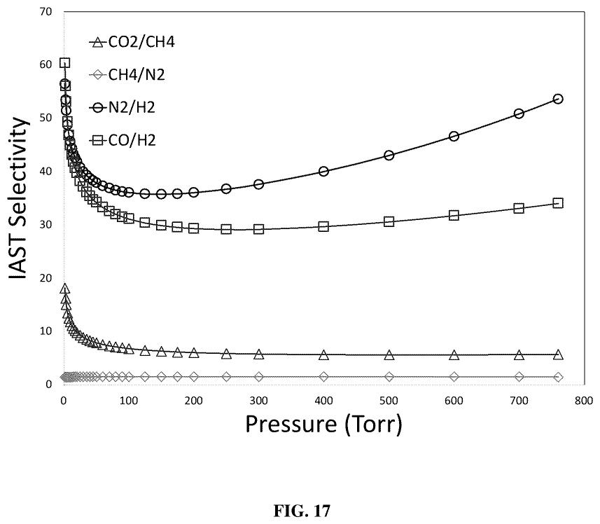

FIG. 17 illustrates a graphical representation showing an ideal adsorbed solution theory (IAST)-selectivity of gas pairs on an acid/expanded polystyrene (A/E) ratio of 1.75 mL/g at 298 Kelvin (K).

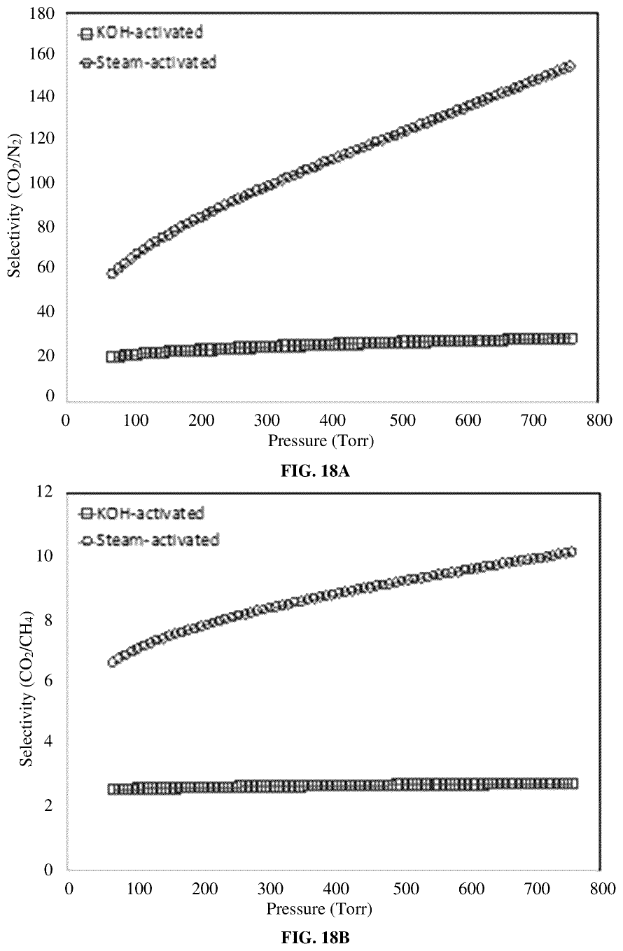

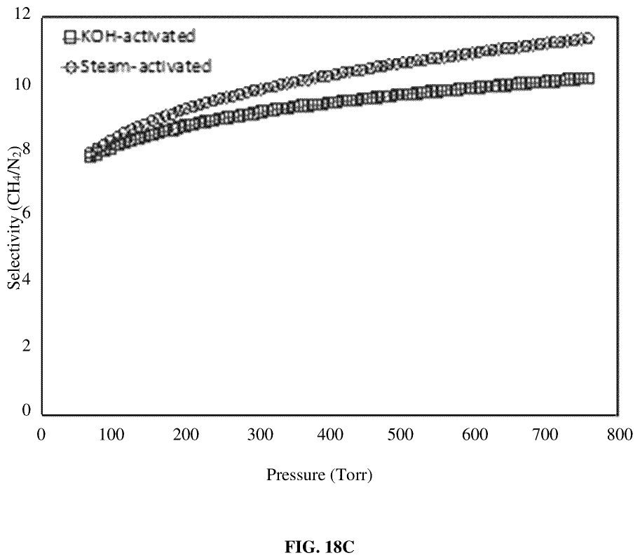

FIGS. 18A-18C illustrate graphical representations showing an ideal adsorbed solution theory (IAST)-selectivity of gas pairs on potassium hydroxide (KOH)-activated carbons and steam-activated carbons at 298 Kelvin (K). IAST selectivity of activated carbons are illustrated in FIGS. 18A-18C for CO₂/N₂, CO₂/CH₄, and CH₄/N₂, respectively. As illustrated in FIGS. 18A-18C, expanded polystyrene-steam-3 demonstrates a higher selectivity for all the pairs CO₂/N₂, CO₂/CH₄, and CH₄/N₂, despite expanded polystyrene-KOH-3 possessing a higher surface area. The high selectivity can be caused by the nature of the isotherms that is, in turn, caused by a narrow pore size and the presence of surface functionalities.

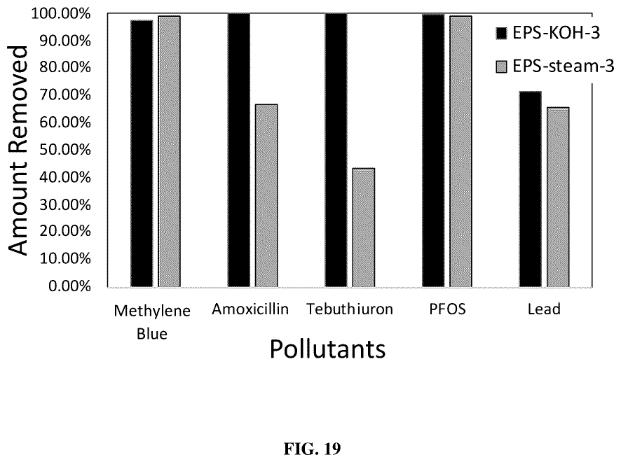

FIG. 19 illustrates a graphical representation showing water purification characteristics of potassium hydroxide (KOH)-activated carbons and steam-activated carbons at 298 Kelvin (K). The results of water purification studies for two types of activated carbons, that is, expanded polystyrene-KOH-3 and expanded polystyrene-steam-3 are illustrated in FIG. 19 for the model pollutants of methylene blue, amoxicillin, tebuthiuron, perfluorooctane sulfonic acid (PFOS), and lead. The graphical representation in FIG. 19 illustrates almost all the methylene blue and PFOS have been separated by both types of carbon. Expanded polystyrene-KOH-3 performs better than that of expanded polystyrene-steam-3 for amoxicillin, tebuthiuron, and lead.

Besides gas separation and water purification disclosed herein, there are many other applications of the resultant carbons, for example, in gasoline vapor emissions control systems, decolorization of food and beverages, deodorization and contaminant reduction of chemicals and catalysis, municipal and point-of-use water treatment, sorbent media for adsorbed natural gas (ANG) technology, air filtration, pharmaceuticals, supercapacitors, chromatography, and gold recovery.

In the process disclosed herein, pristine expanded polystyrene is sulfonated by concentrated sulfuric acid in varying ratios. The resultant sulfonated polystyrene demonstrates a highly enhanced carbon yield of, for example, about 7% to about 35%. The sulfonated polystyrene has been characterized with Fourier transform infrared (FTIR) and X-ray photoelectron spectroscopy (XPS). Upon carbonizing the sulfonated polystyrene at up to about 800° C. and under a nitrogen gas (N₂) flow, a carbon molecular sieve (CMS) is generated without the need for additional activation. The surface area and the pore volume of the carbon molecular sieve materials vary, for example, from about 360 m²/g to about 489 m²/g, and about 0.19 m²/g to about 0.24 m²/g, respectively. The carbon molecular sieve materials are highly microporous with the majority of pore widths centered, for example, around 3.5 Å to 8.5 Å. The evolved gas analysis in the course of carbonization reveals no emission of carbon dioxide (CO₂), thereby not contributing to carbon emissions. The carbon molecular sieve is characterized with pore textural properties, XPS, and electron microscopy. After successfully obtaining the carbon molecular sieve, the carbon molecular sieve materials are further activated with steam and potassium hydroxide (KOH) at elevated temperatures to increase the porosity. The Brunauer-Emmett-Teller (BET) surface area and the pore width of the activated carbons vary, for example, from about 994 m²/g to about 3039 m²/g, and about 0.45 cm³/g to about 1.38 cm³/g, respectively. Both the carbon molecular sieve and activated carbons have been utilized in gas separation and water purification purposes and can be used in many other potential applications.

The process discloses the development of porosity in the carbon molecular sieve and the activated carbon in the course of producing the carbonaceous materials from the expanded polystyrene as disclosed in the descriptions of FIGS. 9-13. The process discloses the role of sulfonating conditions on the degree of porosity. Even before activation, the carbon molecular sieve synthesized in the process has a high porosity as disclosed above. In conventional processes where no organic solvents are employed for sulfonating the expanded polystyrene and instead, sulfonation is directly performed by sulfuric acid and paraformaldehyde, due to the insolubility of expanded polystyrene in sulfuric acid or paraformaldehyde, there is a possibility of a core-shell reaction, that is, the reaction or sulfonation happens on an outer side, that is, a shell side, and an inner side, that is, a core-side, is unreacted. In the process disclosed herein, since the organic solvent completely dissolves the expanded polystyrene, the sulfonation reaction using the organic solvent and the sulfuric acid only is homogeneous. Since the sulfonation process is performed in an organic solvent, a substantially low temperature of, for example, about 50° C., is used for heating the mixture, thereby increasing energy savings. The sulfonation process disclosed herein requires a lower amount of concentrated sulfuric acid as compared to conventional sulfonation processes. Moreover, the sulfonated polystyrene structure produced in the process disclosed herein is not soluble in water. When the sulfonated polystyrene in the organic solvent is quenched in deionized water, coagulation occurs and the sulfonated polystyrene automatically precipitates in the deionized water, thereby precluding loss of the sulfonated product in the process disclosed herein. Furthermore, drying the separated sulfonated polystyrene in a muffle furnace, for example, at about 100° C., requires less utilities than drying the sulfonated polystyrene in a vacuum furnace. Furthermore, the process disclosed herein is less expensive due to the use of nitrogen gas (N₂) in the carbonization process and due to the use of water in the washing process. In the carbonization process disclosed herein, heating is stopped at a relatively low temperature of, for example, about 800° C., for preserving high porosity of the carbon molecular sieve. Furthermore, a relatively low temperature of, for example, about 1000° C., is used in the course of activation of the carbon molecular sieve to enhance porosity. The lower temperatures used in the carbonization and activation processes prevent the pores created in the carbonaceous materials from collapsing. As the ramp rate during carbonization in the process is 10° C./min, the process disclosed herein is faster than conventional processes and increases energy savings.

The foregoing examples and illustrative implementations of various embodiments have been provided merely for explanation and are in no way to be construed as limiting the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, processes and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

We claim:

1. A process for synthesizing an activated carbon from expanded polystyrene, the process comprising:
(a) sulfonating the expanded polystyrene with sulfuric acid in the presence of a solvent to obtain sulfonated polystyrene;
(b) carbonizing the sulfonated polystyrene to obtain a carbon molecular sieve; and
(c) activating the carbon molecular sieve by adding an activating agent to the carbon molecular sieve to obtain an activated carbon, wherein the activating agent is selected from one or more of steam, potassium hydroxide, carbon dioxide, zinc chloride, phosphoric acid, sodium carbonate, aluminum chloride, magnesium chloride, and sodium hydroxide.

2. The process of claim 1, wherein step (a) comprises:
(i) dissolving about 1% to about 30% by weight per volume of the expanded polystyrene in about 80% to about 99% by volume of the solvent to obtain a solution;
(ii) adding about 95% to about 98% by weight of concentrated sulfuric acid to the solution to obtain a mixture;
(iii) heating the mixture to a predetermined temperature in a heating bath under constant stirring for a predetermined time period;
(iv) quenching the heated mixture in one of water and deionized water; and
(v) stirring the quenched mixture for a predetermined time period to obtain the sulfonated polystyrene.

3. The process of claim 2, wherein the predetermined temperature for heating the mixture is about 50 degrees Celsius, wherein the predetermined time period for heating the mixture is about 5 hours, and wherein the predetermined time period for stirring the quenched mixture is about 8 hours.

4. The process of claim 2, further comprising adjusting the concentrated sulfuric acid in the mixture to maintain an expanded polystyrene-to-acid ratio of about 0.11 to about 3.61.

5. The process of claim 2, further comprising:
(vi) washing the sulfonated polystyrene;
(vii) separating the washed sulfonated polystyrene; and
(viii) drying the separated sulfonated polystyrene in a muffle furnace at a predetermined temperature for a predetermined time period to obtain a solid mass of sulfonated polystyrene flakes.

6. The process of claim 5, wherein the predetermined temperature for drying the separated sulfonated polystyrene in the muffle furnace is about 100 degrees Celsius, and wherein the predetermined time period for drying the separated sulfonated polystyrene in the muffle furnace is about 8 hours.

7. The process of claim 2, wherein the heating bath is a silicone oil bath.

8. The process of claim 1, wherein step (b) comprises carbonizing a solid mass of sulfonated polystyrene flakes in a tube furnace at a predetermined elevated temperature at a predetermined ramp rate, and cooling the carbonized mass to room temperature.

9. The process of claim 8, wherein the predetermined elevated temperature for carbonizing the solid mass of sulfonated polystyrene flakes in the tube furnace is about 800 degrees Celsius, and wherein the predetermined ramp rate for carbonizing the solid mass of sulfonated polystyrene flakes in the tube furnace is about 10 degrees Celsius per minute.

10. The process of claim 1, wherein heating and cooling operations in step (b) and step (c) are performed under a nitrogen gas atmosphere.

11. The process of claim 1, wherein the solvent is selected from one or more of chloroform, dichloromethane, acetone, N,N-dimethyl formamide, dimethyl sulfoxide, tetrahydrofuran, toluene, and benzene.

12. The process of claim 1, wherein surface area of the carbon molecular sieve ranges from about 360 square meters per gram (m²/g) to about 489 m²/g, and pore volume of the carbon molecular sieve ranges from about 0.19 m²/g to about 0.24 m²/g, with pore widths around 3.5 angstroms (Å) to about 8.5 Å, and wherein surface area of the activated carbon ranges from about 994 m²/g to about 3039 m²/g, and pore width of the activated carbon ranges from about 0.45 cubic centimeters per gram (cm³/g) to about 1.38 cm³/g.

13. A process for synthesizing a carbon molecular sieve from expanded polystyrene, the process comprising:
(a) sulfonating the expanded polystyrene with sulfuric acid in the presence of a solvent to obtain sulfonated polystyrene; and
(b) carbonizing the sulfonated polystyrene to obtain a carbon molecular sieve.

14. The process of claim 13, wherein surface area of the carbon molecular sieve ranges from about 360 square meters per gram (m²/g) to about 489 m²/g, and pore volume of the carbon molecular sieve ranges from about 0.19 m²/g to about 0.24 m²/g, with pore widths around 3.5 angstroms (Å) to about 8.5 Å.

15. The process of claim 13, further comprising: (c) activating the carbon molecular sieve by one of potassium hydroxide and steam to obtain an activated carbon.

16. The process of claim 15, wherein surface area of the activated carbon ranges from about 994 m²/g to about 3039 m²/g, and pore width of the activated carbon ranges from about 0.45 cubic centimeters per gram (cm³/g) to about 1.38 cm³/g.

17. The process of claim 13, wherein the solvent is selected from one or more of chloroform, dichloromethane, acetone, N,N-dimethyl formamide, dimethyl sulfoxide, tetrahydrofuran, toluene, and benzene.

18. The process of claim 13, wherein step (a) comprises:
(i) dissolving about 1% to about 30% by weight per volume of the expanded polystyrene in about 80% to about 99% by volume of the solvent to obtain a solution;
(ii) adding about 95% to about 98% by weight of concentrated sulfuric acid to the solution to obtain a mixture;
(iii) heating the mixture to a predetermined temperature in a heating bath under constant stirring for a predetermined time period;
(iv) quenching the heated mixture in one of water and deionized water; and
(v) stirring the quenched mixture for a predetermined time period to obtain the sulfonated polystyrene.

19. The process of claim 18, wherein the predetermined temperature for heating the mixture is about 50 degrees Celsius, wherein the predetermined time period for heating the mixture is about 5 hours, and wherein the predetermined time period for stirring the quenched mixture is about 8 hours.

20. The process of claim 18, further comprising adjusting the concentrated sulfuric acid in the mixture to maintain an expanded polystyrene-to-acid ratio of about 0.11 to about 3.61.

21. The process of claim 18, further comprising:
(vi) washing the sulfonated polystyrene;
(vii) separating the washed sulfonated polystyrene; and
(viii) drying the separated sulfonated polystyrene in a muffle furnace at a predetermined temperature for a predetermined time period to obtain a solid mass of sulfonated polystyrene flakes.

22. The process of claim 21, wherein the predetermined temperature for drying the separated sulfonated polystyrene in the muffle furnace is about 100 degrees Celsius, and wherein the predetermined time period for drying the separated sulfonated polystyrene in the muffle furnace is about 8 hours.

23. The process of claim 13, wherein step (b) comprises carbonizing a solid mass of sulfonated polystyrene flakes in a tube furnace at a predetermined elevated temperature at a predetermined ramp rate, and cooling the carbonized mass to room temperature.

24. The process of claim 23, wherein the predetermined elevated temperature for carbonizing the solid mass of sulfonated polystyrene flakes in the tube furnace is about 800 degrees Celsius, and wherein the predetermined ramp rate for carbonizing the solid mass of sulfonated polystyrene flakes in the tube furnace is about 10 degrees Celsius per minute.

25. The process of claim 13, wherein heating and cooling operations are performed under a nitrogen gas atmosphere.
